(19) United States
(12) Patent Application Publication
(10) Pub. No.: US 2025/0200349 A1
(43) Pub. Date: Jun. 19, 2025

(54) METHOD OF TRAINING ARTIFICIAL INTELLIGENCE MODEL BY USING HARDWARE ACCELERATOR, AND HARDWARE ACCELERATOR AND ELECTRONIC DEVICE FOR PERFORMING THE SAME

(71) Applicant: Korea University Research and Business Foundation, Seoul (KR)

(72) Inventors: Jae Ha KUNG, Seoul (KR); Seunghyun Lee, Seoul (KR)

(73) Assignee: Korea University Research and Business Foundation, Seoul (KR)

(21) Appl. No.: 18/602,365

(22) Filed: Mar. 12, 2024

(30) Foreign Application Priority Data
Dec. 18, 2023 (KR) 10-2023-0185069

(51) Int. Cl. G06N 3/063; G06F 7/523; G06N 3/04

(52) U.S. Cl. CPC G06N 3/063; G06F 7/523; G06N 3/04

(57) ABSTRACT

A method of training an artificial intelligence model by using a hardware accelerator includes obtaining a training dataset including a plurality of first block floating-point values having a first block size, performing a training operation on the artificial intelligence model, based on the training dataset, repeating the training operation on the artificial intelligence model for a predefined number of epochs, and reconstructing the training dataset with a plurality of second block floating-point values having a second block size.

### CROSS-REFERENCE TO RELATED APPLICATION

This application is based on and claims priority under 35 U.S.C. § 119 to Korean Patent Application No. 10-2023-0185069, filed on Dec. 18, 2023, in the Korean Intellectual Property Office, the disclosure of which is incorporated by reference herein in its entirety.

### BACKGROUND

### 1. Field

The disclosure relates to a method of training an artificial intelligence model by using a hardware accelerator, and a hardware accelerator and an electronic device for performing the method, and more particularly, to a block floating-point format using an implicit bit, and a hardware accelerator and an electronic device capable of supporting training and inference operations with various precisions and various block sizes by using the block floating-point format.

### 2. Description of the Related Art

High-performance computing systems and continuously growing open-source datasets have led to extremely quick advances of artificial intelligence technology. In addition, along with the improved accuracy in artificial intelligence technology, artificial intelligence technology is used in many applications, such as computer vision, language modeling, and autonomous driving.

To use artificial intelligence for applications, training processes are required. In artificial intelligence technology, training refers to a process of updating weights of artificial intelligence models (for example, deep neural networks (DNNs)) by using specific datasets. As the weights are better updated, artificial intelligence models may perform given tasks better.

However, because training processes require extremely large amounts of calculation, training via central processing units (CPUs) takes extremely much time. Although graphics processing units (GPUs) facilitate parallel processing and thus less training time is required than in the case of CPUs, GPUs exhibit low usage due to the structural nature thereof. Recently, to overcome the drawbacks of CPUs and GPUs, a lot of dedicated hardware accelerators for performing calculations in DNNs have been proposed.

### SUMMARY

According to an aspect of the disclosure, provided is a method of training an artificial intelligence model by using a hardware accelerator. The method may include obtaining a training dataset including a plurality of first block floating-point values having a first block size, performing a training operation on the artificial intelligence model, based on the training dataset, repeating the training operation on the artificial intelligence model for a predefined number of epochs, and reconstructing the training dataset with a plurality of second block floating-point values having a second block size.

According to another aspect of the disclosure, provided is an electronic device. The electronic device may include a memory storing at least one instruction, and at least one processor configured to execute the at least one instruction to obtain a training dataset including a plurality of first block floating-point values having a first block size, perform a training operation on the artificial intelligence model, based on the training dataset, repeat the training operation on the artificial intelligence model for a predefined number of epochs, and reconstruct the training dataset with a plurality of second block floating-point values having a second block size.

According to another aspect of the disclosure, provided is a computer-readable recording medium having recorded thereon a program for performing, in a computer, a method of training an artificial intelligence model by using a hardware accelerator.

### BRIEF DESCRIPTION OF THE DRAWINGS

The disclosure may be easily understood by combinations of the following detailed description and the accompanying drawings, and the reference numerals respectively refer to structural elements.

The above and other aspects, features, and advantages of certain embodiments of the disclosure will be more apparent from the following description taken in conjunction with the accompanying drawings, in which:

FIG. 1 is a conceptual diagram illustrating a calculation environment of an artificial intelligence model, according to an embodiment;

FIG. 2 is a conceptual diagram illustrating a block floating point according to an embodiment;

FIG. 3 is a block diagram illustrating a configuration of an electronic device according to an embodiment;

FIG. 4 is a conceptual diagram illustrating a method of converting a floating-point value into a block floating-point value, according to an embodiment;

FIG. 5 is a flowchart illustrating a method of converting a floating-point value into a block floating-point value, according to an embodiment;

FIG. 6 is a flowchart illustrating a method of changing a bit-width or precision, according to an embodiment;

FIG. 7 is a flowchart illustrating detailed operations of operation S630 of FIG. 6;

FIG. 8 is a flowchart illustrating a method of changing a block size, according to an embodiment;

FIG. 9 is a flowchart illustrating a method of processing a block floating-point value, according to an embodiment;

FIG. 10 is a flowchart illustrating a method of training an artificial intelligence model by using a hardware accelerator, according to an embodiment;

FIG. 11 is a flowchart illustrating a method of training an artificial intelligence model by using a hardware accelerator, according to an embodiment;

FIG. 12 is a flowchart illustrating detailed operations of operation S1020 of FIG. 10;

FIG. 13 is a flowchart illustrating detailed operations of operation S1230 of FIG. 12;

FIG. 14 is a flowchart illustrating detailed operations of operation S1320 of FIG. 13;

FIG. 15 is a block diagram illustrating a configuration of a hardware accelerator according to an embodiment;

FIG. 16 is a block diagram illustrating examples of a configuration and operations of a sub-core according to an embodiment;

FIG. 17 is a block diagram illustrating examples of a configuration and operations of a sub-core according to an embodiment;

FIG. 18 is a block diagram illustrating examples of a configuration and operations of a sub-core according to an embodiment;

FIGS. 19A and 19B are block diagrams each illustrating examples of a configuration and operations of a selective adder tree according to an embodiment; and

FIG. 20 is a conceptual diagram illustrating operations of an electronic device according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Although terms used herein are of among general terms which are currently and broadly used by considering functions in the disclosure, these terms may vary according to intentions of those of ordinary skill in the art, precedents, the emergence of new technologies, or the like. In addition, there may be terms selected arbitrarily by the applicants in particular cases, and in these cases, the meaning of those terms will be described in detail in the corresponding portions of the detailed description. Therefore, the terms used herein should be defined based on the meaning thereof and descriptions made throughout the specification, rather than based on names simply called.

The singular terms used herein are intended to include the plural forms as well, unless the context clearly indicates otherwise. All terms used herein, including technical and scientific terms, have the same meaning as generally understood by those of ordinary skill in the art.

It will be understood that, throughout the specification, when a region such as an element, a component, a layer, or the like is referred to as “comprising” or “including” a component such as an element, a region, a layer, or the like, the region may further include another component in addition to the component rather than exclude the other component, unless otherwise stated. In addition, the term such as “ . . . unit”, “ . . . portion”, “ . . . module”, or the like used herein refers to a unit for processing at least one function or operation, and this may be implemented by hardware, software, or a combination of hardware and software.

The expression “configured (or set) to” used herein may be used interchangeably with, for example, “suitable for”, “having the capacity to”, “designed to”, “adapted to”, “made to”, or “capable of” depending on the circumstances. The expression “configured (or set) to” does not essentially mean “specially designed in hardware to”. Rather, in some circumstances, the expression “system configured to” may mean that the system may perform an operation together with another device or parts. For example, the phrase “processor configured (or set) to perform A, B, and C” may mean a dedicated processor (for example, an embedded processor) for performing the operations, or a generic-purpose processor (for example, a CPU or an application processor) that may perform the operations by executing one or more software programs stored in a memory.

In addition, throughout the specification, it should be understood that, when a component is referred to as being “coupled to” or “connected to” another component, the component may be directly coupled to or directly connected to the other component or may be coupled to or connected to the other component with an intervening component therebetween, unless otherwise stated.

In the disclosure, functions related to “artificial intelligence” are operated by a processor and a memory. The processor may include one or more processors. Here, the one or more processors may include a general-purpose processor, such as a CPU, an application processor (AP), or a digital signal processor (DSP), a dedicated graphics processor, such as a graphics processing unit (GPU) or a vision processing unit (VPU), or a dedicated artificial intelligence processor, such as a neural processing unit (NPU). The one or more processors control input data to be processed according to an artificial intelligence model or predefined operation rules stored in a memory. Alternatively, when the one or more processors include dedicated artificial intelligence processors, the dedicated artificial intelligence processors may be designed with a hardware structure specialized in processing a specific artificial intelligence model.

The artificial intelligence model or the predefined operation rules are characterized by being made by training. Here, “being made by training” means that a basic artificial intelligence model is trained by a learning algorithm by using a large number of pieces of training data, and thus, the artificial intelligence model or the predefined operation rules set to perform intended features (or purposes) are made. Such training may be performed by a device itself in which artificial intelligence according to the disclosure is performed, or may be performed by a separate server and/or system. The learning algorithm may include, but is not limited to, for example, supervised learning, unsupervised learning, semi-supervised learning, or reinforcement learning.

In an embodiment of the disclosure, an “artificial intelligence model” may include a neural network model. The neural network model may include a plurality of neural network layers. Each of the plurality of neural network layers has a plurality of weight values and performs a neural network operation through an operation between an operation result of a previous layer and the plurality of weight values. The plurality of weight values of each of the plurality of neural network layers may be optimized by a training result of the artificial intelligence model. For example, the plurality of weight values may be updated such that a loss value or a cost value obtained by the artificial intelligence model during a training process is minimized. An artificial neural network model may include a deep neural network (DNN), for example, a convolutional neural network (CNN), a recurrent neural network (RNN), a restricted Boltzmann machine (RBM), a deep belied network (DBN), a bidirectional recurrent deep neural network (BRDNN), or a deep Q-network, but the disclosure is not limited thereto.

In the disclosure, a tensor may denote an n-dimensional array of data. Each dimension of the tensor may form an axis. For example, a 0-dimensional tensor may represent a scalar value, a 1-dimensional tensor may represent a vector value, and a 2-dimensional tensor may represent a matrix. For example, a 3 or more-dimensional tensor may include a plurality of matrices and may form 3 or more axes.

In the disclosure, a batch may indicate a unit for updating parameters by grouping all datasets for the training of the artificial intelligence model. For example, all the datasets may be grouped into a plurality of batches. The parameters of the artificial intelligence model may be updated for every one batch. One batch may include a predefined number of mini-batches.

Specific mathematical expressions (such as equations) described below are only examples from among various possible alternatives, and the scope of the disclosure should not be construed as being limited to the mathematical expressions described herein.

Hereinafter, embodiments of the disclosure will be described in detail with reference to the accompanying drawings such that those of ordinary skill in the art may easily implement the embodiments. However, the disclosure may be implemented in different ways and is not limited to the embodiments described herein.

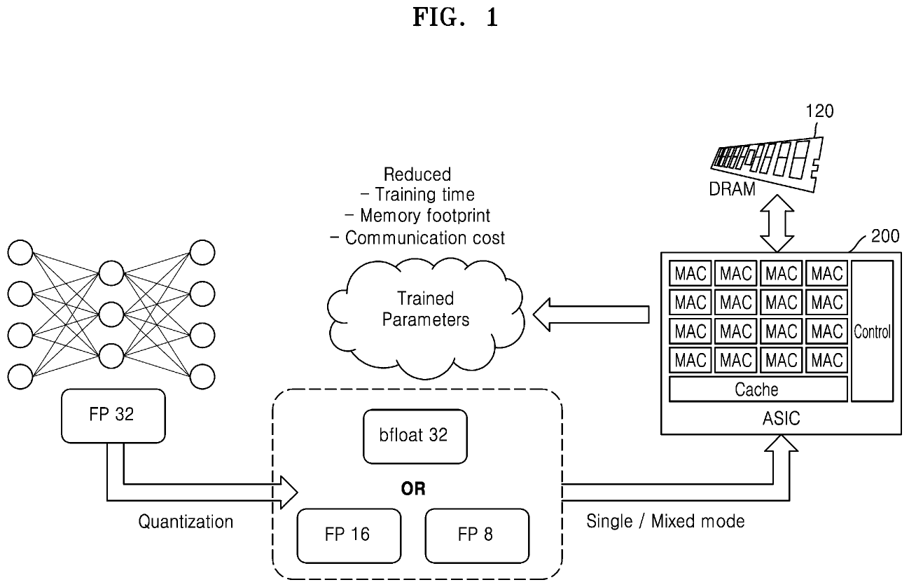

FIG. 1 is a conceptual diagram illustrating an operation environment of an artificial intelligence model, according to an embodiment.

In an embodiment, a processor 200 may receive an input value for training an artificial intelligence model. The artificial intelligence model may include at least one layer. The at least one layer may include a plurality of weight values and/or a plurality of bias values. At least one of an input value, a weight value, and a bias value may be configured in a predefined data format. For example, although the predefined data format may include FP32, the disclosure is not limited thereto, and the predefined data format may include various data formats.

However, when FP32 is used for all data, a memory 120 having a large capacity is required, and a high communication cost is incurred during the process of transmission and reception of the data. In an embodiment, values in the predefined data format may be quantized to a more efficient data format. According to an embodiment, before the input value, the weight value, and/or the bias value are input to the processor 200, data requirements varying in real time may be more effectively responded to, and optimum results in terms of power consumption and processing speed may be obtained.

In an embodiment, the predefined data format may be quantized to bfloat32, FP16, and/or FP8. The processor 200 may receive quantized values and thus perform a multiplication operation between the input value and the weight value. The processor 200 may update a parameter (for example, the weight value) of the artificial intelligence model by using a result of the multiplication operation. The processor 200 may store the updated parameter in the memory 120.

However, when the artificial intelligence model is trained in the floating-point format (for example, FP32, FP16, FP8, bfloat32, or the like) shown in FIG. 1, a greater memory space is required than that in the INT format, and there is an issue of great power consumption.

A hardware accelerator according to an embodiment may convert values in a floating-point format into values in a block floating-point format. The hardware accelerator according to an embodiment may perform a multiply and accumulation (MAC) operation in the INT format on signs and mantissas of the values in a block floating-point format. The specific configurations, functions, and operations of the hardware accelerator according to an embodiment, and a method of converting a floating-point value into a block floating-point value, are described below.

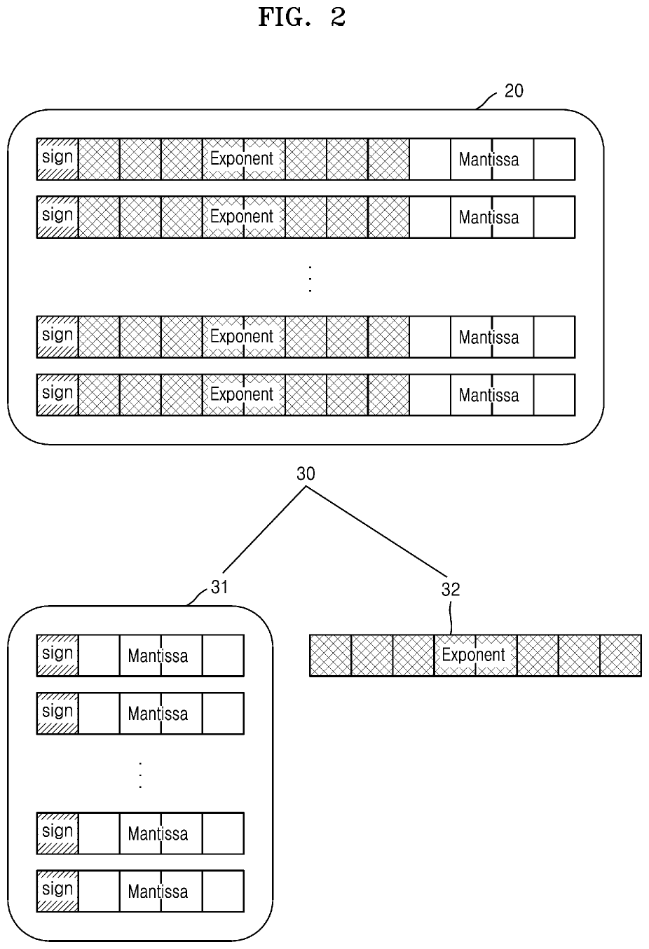

FIG. 2 is a conceptual diagram illustrating a block floating point according to an embodiment.

In the disclosure, operations are performed in a block floating-point format. Before the block floating-point format is described, an expression method of a floating-point value is described.

Floating-point values may include various forms depending on the precision thereof, and the most used form is FP32 (20) that is a format prescribed by IEEE. The FP32 (20) may represent a real number by division into a sign, an exponent, and a mantissa. For example, a floating-point value may be represented by Equation 1 as follows.

$${x}_{i} = {( - 1 )}^{{s}_{i}} \cdot {m}_{i} \cdot {2}^{{e}_{i}} \qquad [ Equation 1 ]$$

In Equation 1, xi is defined as a real value, si is defined as a sign, mi is defined as a mantissa, and ei is an exponent value for the real value.

In FP32 (20), a sign is represented by 1 bit, a mantissa is represented by 23 bits, and an exponent value is represented by 8 bits, thereby representing a floating-point value by a total of 32 bits.

However, when data processing is performed on all values by 32 bits, a lot of resources may be wasted during the processing process. In the disclosure, the concept of “block floating point” (which may be alternatively referred to as “BFP”) is introduced, thereby representing various data by the same exponent.

Specifically, a BFP 30 shares the greatest exponent 32 from among exponents of N values in one block. That is, as shown in the right side in FIG. 2, several values are caused to have the same exponent value (shared exponent 32), and each value 31 is caused to have only a sign and a mantissa value for the shared exponent value. For example, a plurality of real values may be represented by Equation 2 as follows.

$$\vec{x} = [ {x}_{1} , {x}_{2} , … , {x}_{N} ] = [ \hat{{x}_{1}} , \hat{{x}_{2}} , … , \hat{{x}_{N}} ] \cdot {2}^{{e}_{x}} = \vec{\hat{x}} \cdot {2}^{{e}_{x}} \qquad [ Equation 2 ]$$

In Equation 2, es is a shared exponent value of a block and eₛ=└log₂(max(|x₁, . . . ,|x_{N}|)┘. In an embodiment, each value includes only a sign and a mantissa as shown in Equation 3 below.

$${\hat{x}}_{i} = \{ {s}_{i} , {m}_{i} \} \qquad [ Equation 3 ]$$

As such, by using a block floating point, data storage space may be significantly reduced and real-number operations may be performed by only integer arithmetic.

In addition, the sign and the mantissa are made to support various sizes, depending on precision. For example, the sign and the mantissa may collectively have a size of 4 bits, 8 bits, or 16 bits. In an embodiment, the size of the sign-and-mantissa may be applied differently for each phase in a training process. For example, a sign-and-mantissa having 4 bits may be used during a feature map calculation, and a sign-and-mantissa having 8 bits or 16 bits may be used during a local gradient calculation or a weight update.

As such, because mantissas (or sign-and-mantissas) with various sizes are supported in the disclosure, a model generated according to the disclosure may be executed even on accelerators supporting CPUs/GPUs with precision (for example, bfloat 16) using the same exponent bits. In addition, by controlling a handler that manages exponents, operations of integers with 4-bit, 8-bit, and 16-bit sizes may also be performed.

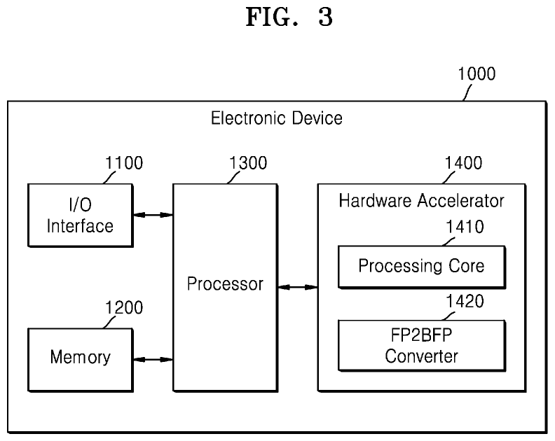

FIG. 3 is a block diagram illustrating a configuration of an electronic device 1000 according to an embodiment.

Referring to FIG. 3, the electronic device 1000 may include an input/output interface 1100, a memory 1200, a processor 1300, and a hardware accelerator 1400. The electronic device 1000 may include a device, such as a personal computer (PC), a notebook, or a server, or a mobile device, such as a smartphone.

The input/output interface 1100 may include an input interface and an output interface.

In an embodiment, the input interface is for receiving an input from a user (hereinafter, referred to as a user input). The input interface may include, but is not limited to, at least one of a keypad, a dome switch, a touch pad (a touch capacitive type, a pressure resistive type, an infrared beam sensing type, a surface acoustic wave type, an integral strain gauge type, a piezoelectric type, or the like), a jog wheel, a jog switch, and a microphone.

In an embodiment, the electronic device 1000 may receive a user input, which corresponds to a hyperparameter of an artificial intelligence model, through the input interface. For example, although the hyperparameter may include learning precision, a block size of a block floating point, the frequency of precision change, the frequency of block size change, a learning rate, the number of epochs, a batch size, an activation function, a dropout rate, a normalization parameter, or the like, the disclosure is not limited thereto, and the hyperparameter may include information required for the training of the artificial intelligence model or for the inference by the artificial intelligence model. In an embodiment, the electronic device 1000 may receive a user input, which corresponds to an input value of the artificial intelligence model, through the input interface. The user input received through the input interface may be transferred to the processor 1300. The processor 1300 may perform the training of the artificial intelligence model and/or the inference via the artificial intelligence model, based on the user input.

In an embodiment, the output interface is for outputting an audio signal or a video signal and may include, for example, a display, a speaker, or the like. The display may display a user interface window for receiving the selection of a function supported by the electronic device 1000. Specifically, the display may display a user interface window for receiving the selection of various functions provided by the electronic device 1000. The display may include a monitor, such as a liquid crystal display (LCD) or an organic light-emitting diode (OLED) display, or a touchscreen.

The display may display a message requesting the input of various parameters to be applied to a training process. When parameters are input, the parameters may be directly input by a user or may be automatically selected depending on characteristics of the artificial intelligence model and characteristics of datasets.

In an embodiment, the electronic device 1000 may display, via the display, a user interface window for inputting the hyperparameter of the artificial intelligence model. The electronic device 1000 may display a training progress of the artificial intelligence model to the user via the display.

The memory 1200 may store programs for the processing and control by the processor 1300 and/or the hardware accelerator 1400 and store pieces of data which are input and output. The memory 1200 may store at least one instruction regarding the electronic device 1000. The memory 1200 may store at least one artificial intelligence model. For example, the memory 1200 may store a DNN required for machine learning or deep learning. Here, although the DNN may be a deep learning network, the DNN is not limited to the term and may include any model so long as the model may undergo the update of internal weights by datasets.

In an embodiment, the memory 1200 may store data processed or to be processed by the processor 1300, firmware, software, process code, and the like. In an embodiment, the memory 1200 may store a training dataset for training the artificial intelligence model. In an embodiment, the memory 1200 may store data and program codes required for the training of the artificial intelligence model and/or the inference by the artificial intelligence model. In an embodiment, the memory 1200 may store weight values and/or bias values of at least one layer of the artificial intelligence model.

The memory 1200 may include at least one of a flash memory type memory, a hard disk type memory, a multimedia card micro type memory, a card type memory (for example, an SD or XD memory or the like), random access memory (RAM), static random access memory (SRAM), read-only memory (ROM), electrically erasable programmable read-only memory (EEPROM), programmable read-only memory (PROM), magnetic memory, a magnetic disk, and an optical disk. In an embodiment, at least some functions of the memory 1200 may be performed by a web storage or a cloud server, which performs a storage function on the Internet.

The processor 1300 may control all operations of electronic device 1000. The processor 1300 may be configured to execute the at least one instruction stored in the memory 1200 to control all operations of the electronic device 100. For example, the processor 1300 may include one or more processors. Here, the one or more processors may include a general-purpose processor, such as a CPU, an AP, or a DSP, or a dedicated graphics processor, such as a GPU or a VPU.

The processor 1300 may control operations of the hardware accelerator 1400. For example, the processor 1300 may generate a control signal for controlling the hardware accelerator 1400 and may provide the generated control signal to the hardware accelerator 1400. Here, the control signal may include information, such as a network type, the number of layers, the dimension of data, ReLU, a pooling option, a block size, precision, or the like. The processor 1300 may instruct the hardware accelerator 1400 to perform the training of a specific artificial intelligence model and/or the inference by the specific artificial intelligence model. The processor 1300 may provide or receive data required by the hardware accelerator 1400. For example, the processor 1300 may load data (for example, weights and/or biases) of a specific artificial intelligence model stored in the memory 1200. The processor 1300 may transfer the loaded data to an internal memory (not shown) of the hardware accelerator 1400. The processor 1300 may transfer a training dataset (for example, an input value) stored in the memory 1200 to the internal memory (not shown) of the hardware accelerator 1400.

The hardware accelerator 1400 may perform operations related to the artificial intelligence model. The hardware accelerator 1400 may perform operations in a block floating-point format and may perform calculation operations in various precisions and/or various block sizes. In an embodiment, the hardware accelerator 1400 may support various data types sharing an exponent or having no exponent. For example, the hardware accelerator 1400 may support a first data type of a fixed-point type, a second data type having only an integer, a third data type having a sign and an integer, and a fourth data type of a real-number type sharing an exponent (that is, of a block floating-point type).

The hardware accelerator 1400 may receive a first tensor (for example, an input value) and a second tensor (for example, a weight value), which are of a floating-point type. The hardware accelerator 1400 may convert the first tensor (for example, an input value) and the second tensor (for example, a weight value), which are of a floating-point type, into a block floating-point type. The hardware accelerator 1400 may perform a multiplication operation between the first tensor (for example, an input value) and the second tensor (for example, a weight value), which are of a block floating-point type. For convenience of description, the following description is made under the assumption that the first tensor is a tensor including an input value and the second tensor is a tensor including a weight value, but the disclosure is not limited thereto.

The hardware accelerator 1400 may include a processing core 1410 and an FP2BFP converter 1420. The hardware accelerator 1400 may receive a control signal from the processor 1300 and may optimize the control signal depending on an operation state of the processing core 1410. The hardware accelerator 1400 may distribute the control signal to respective components of the processing core 1410. The processing core 1410 may perform a convolution operation and/or a general matrix multiply (GEMM) operation or perform a multiply and accumulation (MAC) operation for performing the convolution operation and/or the GEMM operation.

The processing core 1410 may include a plurality of multipliers that are hierarchically configured. In an embodiment, the processing core 1410 may include an integer multiplier and an adder. For example, a hierarchical configuration, such as a multiplier->a processing element (PE, or a processing engine)->a sub-core->a processing core, may be provided.

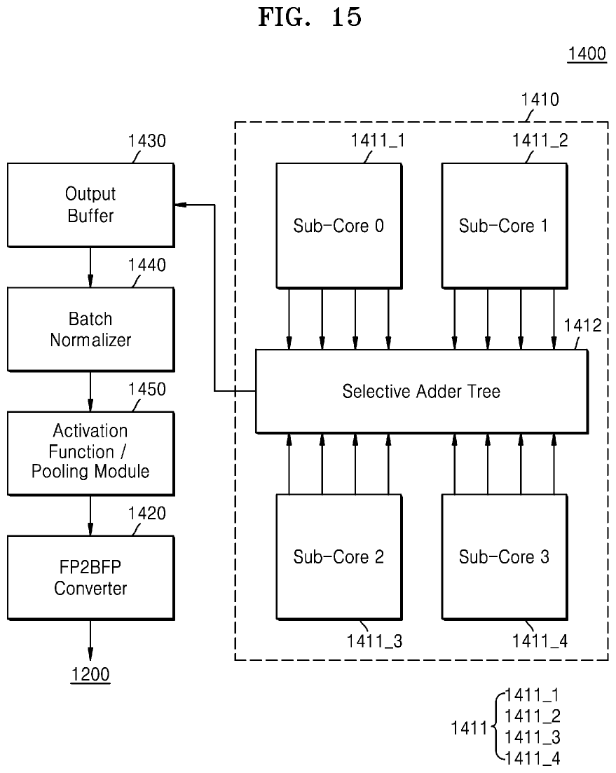

The processing core 1410 may include a plurality of sub-cores, and each of the sub-cores may include a plurality of PEs. Each of the PEs may include a plurality of multipliers. In FIGS. 15 to 20 described below, although it is illustrated that the processing core 1410 includes four sub-cores, each sub-core includes 16 PEs (or processing engines), and each PE includes 8 multipliers, this is only an example, and the disclosure is not limited thereto.

The processing core 1410 may calculate by using only an effective number (that is, a sign and a mantissa) of a block floating-point value, and an exponent thereof may be separately processed by a shared exponent handler (not shown). For example, the shared exponent handler (not shown) may process an operation between a shared exponent of the first tensor and a shared exponent of the second tensor. The shared exponent handler (not shown) may be included in the hardware accelerator 1400 or the processor 1300.

The FP2BFP converter 1420 may convert a floating-point value into a block floating-point value. An output of the processing core 1410 may be a floating-point value. The FP2BFP converter 1420 may determine an exponent of a value, which has a maximum exponent within a block size from among a plurality of floating-point values, to be a shared exponent. For example, the block size may be different depending on a block floating-point format (for example, FB12, FB16, or FB24), a training progress, and/or a layer type (for example, CONV1/FC, CONV3, CONV5, or CONV7) and may also be different depending on settings by a user or a manufacturer. The FP2BFP converter 1420 may store an index of the value having the maximum exponent in the memory 1200 or in the internal memory (not shown) of the hardware accelerator 1400. The FP2BFP converter 1420 may subtract an exponent of each of the input values from the shared exponent. That is, the FP2BFP converter 1420 may receive the shared exponent and the exponents of the input values of the same block and thus calculate an exponent value in a block floating-point format. The FP2BFP converter 1420 may perform normalization based on the calculated exponent value. Here, the normalization refers to changing a mantissa into the form of “1.xxx . . . ”. To calculate a mantissa value during the conversion into a block floating-point format, the FP2BFP converter 1420 may perform an operation of moving an effective number of an implicit bit and explicit bits by using a barrel shifter, thereby adjusting an effective value (that is, a mantissa) in correspondence with the previously calculated exponent value. The barrel shifter may adjust the mantissa to a predefined precision or bit-width.

The FP2BFP converter 1420 may determine or count the number of underflow occurrences due to the adjustment of the mantissa. Herein, the underflow may refer to a phenomenon in which all bits of the mantissa have “0” by bit-shifting. The FP2BFP converter 1420 may transfer the determined number of underflow occurrences to the processor 1300 and/or the processing core 1410. The processor 1300 and/or the processing core 1410 may change the predefined precision or bit-width to a different precision or bit-width, based on the determined number of underflow occurrences. The FP2BFP converter 1420 may adjust the mantissa to the changed precision or bit-width.

Although not shown, the hardware accelerator 1400 may include an arithmetic converter (not shown). The arithmetic converter (not shown) may convert a block floating-point value into a floating-point value. The arithmetic converter (not shown) may include at least one of a data type converter, a leading zero counter, a barrel shifter, and a normalizer. According to an embodiment, batch normalization, which is sensitive to precision and a data format, may be performed with a value converted into a floating-point value, and thus, learning accuracy may be preserved. The arithmetic converter (not shown) may output a floating-point value based on an exponent operation result output by the shared exponent handler and on a sign-and-mantissa operation result output by the processing core 1410.

In an embodiment, because the hardware accelerator 1400 is a “dedicated processor” for the inference via the artificial intelligence model and/or the training of the artificial intelligence model, the hardware accelerator 1400, together with the processor 1300 that is a general-purpose processor, may be collectively referred to as a “processor”.

In an embodiment, at least some components and/or functions of the hardware accelerator 1400 may be included in or performed by the processor 1300. For example, the processor 1300 may perform the function of the FP2BFP.

In an embodiment, the hardware accelerator 1400 may perform a calculation operation with different precision during various calculation processes of the artificial intelligence model. Specifically, the processor 1300 may convert data into a first size (for example, 4 bits or 8 bits) in at least one of a forward pass process and a backward pass process and convert data into a mantissa having a second size (for example, 16 bits), which is greater than the first size, in a weight update process, thereby performing a training operation. In addition, in the weight update process, a loss gradient map may be divided into predefined sizes, and a calculation operation may be performed in units of divided loss gradient maps.

As described above, because the electronic device 1000 according to the disclosure may perform training and/or inference by using the hardware accelerator 1400 used only for the training of the artificial intelligence model (for example, a DNN) and/or the inference via the artificial intelligence model, the electronic device 1000 may quickly perform a training or inference operation. In addition, because the electronic device 1000 according to the disclosure performs a training process by using a block size and/or precision suitable for each phase in the training process without using a fixed block size and/or precision in the training process, the electronic device 1000 may efficiently manage power consumption. In addition, the electronic device 1000 according to the disclosure may store indices of values having a maximum exponent from among block floating-point values, thereby efficiently using a memory.

Heretofore, although descriptions have been made under the assumption that the hardware accelerator 1400 and the processor 1300 are included in one electronic device 1000, the hardware accelerator 1400 and the processor 1300 may be respectively configured to be different electronic devices. In addition, regarding FIG. 3, although the above operations have been described as being applied only to a training process of the artificial intelligence model, the above operations may also be applied to an inference process using the trained artificial intelligence model.

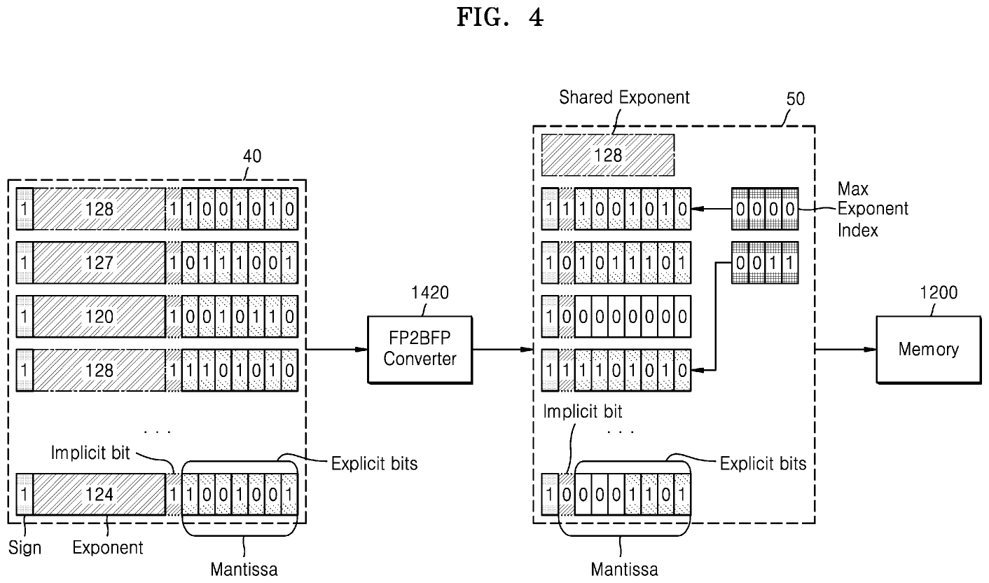

FIG. 4 is a conceptual diagram illustrating a method of converting a floating-point value into a block floating-point value, according to an embodiment. The configurations, functions, and operations of the FP2BFP 1420 converter and the memory 1200 may respectively correspond to the configurations, functions, and operations of the FP2BFP converter 1420 and the memory 1200 in FIG. 3. For convenience of description, the descriptions given with reference to FIGS. 1 to 3 are omitted.

Referring together to 3 and 4, the FP2BFP converter 1420 may obtain a plurality of floating-point values 40. For example, the FP2BFP converter 1420 may obtain the plurality of floating-point values 40 from the memory 1200 or from the internal memory of the hardware accelerator 1400. Each of the plurality of floating-point values 40 may include a sign, an exponent, and a mantissa. For example, although each of the plurality of floating-point values 40 is shown as having a bfloat16 format including 1 bit of the sign, 8 bits of the exponent, and 7 bits (8 bits including an implicit bit) of the mantissa, the disclosure is not limited thereto, and each of the sign, the exponent, and the mantissa may have various bit-widths.

The mantissa may include an implicit bit having 1 bit and explicit bits respectively having a plurality of bits. The implicit bit may indicate a bit before a decimal point, and the explicit bits may indicate bits (or precision) after the decimal point. The implicit bit may indicate a bit not to be stored in a memory, and the explicit bits may indicate bits to be stored in the memory. The implicit bit is always set to a specific value (for example, “1”) and thus may not occupy a memory space. For example, the mantissa may be represented in the form of “1.xxx . . . ”, and in particular, “1” before the decimal point may be represented by an implicit bit and “xxx . . . ” after the decimal point may be represented by explicit bits.

The implicit bit may indicate a bit located in the leftmost place in a mantissa of a floating-point format. The implicit bit may indicate the most significant bit of the mantissa. For example, when the mantissa includes 8 bits, the most significant 1 bit may be an implicit bit and the other 7 bits may be explicit bits.

The FP2BFP converter 1420 may respectively convert the plurality of floating-point values 40 into a plurality of block floating-point values 50. The plurality of block floating-point values 50 may correspond to one block. The FP2BFP converter 1420 may determine, as a shared exponent, an exponent of at least one first floating-point value having a maximum exponent, from among a plurality of floating-point values. In FIG. 4, among the exponents of the plurality of floating-point values 40, the maximum exponent is indicated by a dash-single dotted line. The FP2BFP converter 1420 may store an exponent of a first floating-point value having the maximum exponent in the memory 1200 or in the internal memory (not shown) of the hardware accelerator 1400. The FP2BFP converter 1420 may store an index of the first floating-point value having the maximum exponent in the memory 1200 or in the internal memory (not shown) of the hardware accelerator 1400. For example, the index of the first floating-point value may also be referred to as a maximum exponent index. The maximum exponent index may be mapped to bits corresponding to the sign and mantissa of the first floating-point value. When the floating-point value has the maximum exponent index, the implicit bit of the mantissa may be interpreted to be “1”.

For a second floating-point value not having the maximum exponent, from among the plurality of floating-point values, the FP2BFP converter 1420 may calculate a difference between the shared exponent and an exponent of the second floating-point value. For example, when the shared exponent represents “128” and the second floating-point value represents “124”, the difference in exponent therebetween may be “4”. The FP2BFP converter 1420 may right-shift the bits of the mantissa of the second floating-point value by as much as the calculated difference in exponent. The bits of the mantissa may include an implicit bit and explicit bits. For example, when the implicit bit of the mantissa of the second floating-point value is “1”, the explicit bits thereof are “1000101”, and the difference in exponent is “4”, the FP2BFP converter 1420 may convert the implicit bit of the mantissa of the second floating-point value into “0” and the explicit bits thereof into “0001100”.

In an embodiment, the FP2BFP converter 1420 may include a rounder. The rounder may identify bits to be discarded by a shift operation. The rounder may round off the bits of the mantissa having a predefined bit width, based on the identified bits. For example, when the implicit bit of the mantissa of the second floating-point value is “1”, the explicit bits thereof are “1001001”, and the difference in exponent is “4”, the FP2BFP converter 1420 may convert the implicit bit of the mantissa of the second floating-point value into “0” and the explicit bits thereof into “0001101”. However, the disclosure is not limited thereto, and the FP2BFP converter 1420 may include a logic circuit configured to perform a round-up operation or a round-down operation, instead of the rounder.

The FP2BFP converter 1420 may store the sign and the converted explicit bits of the mantissa in the memory 1200 or in the internal memory (not shown) of the hardware accelerator 1400.

According to an embodiment, the implicit bit of the mantissa in a floating-point format may be used even in a block floating-point format, and thus, the number of bits for representing the mantissa may be saved.

An average number of bits required to store a block floating-point value, which does not use an implicit bit, may follow Equation 4.

$${BFP}_{bit} = len ( s + m ) + \frac{len ( {e}_{s} )}{N} \qquad [ Equation 4 ]$$

Referring to Equation 4, BFP_{bit} is defined to be the number of bits of each of values that are included in a specific block and having a block floating-point format, len(s+m) is defined to be a bit-width of a sign-and-mantissa, N is defined to be a block size of the block, and len(eₛ) is defined to be a bit-width of a shared exponent. For example, when the bit-width of the sign-and-mantissa is 8, the block size of the block is 64, and the bit-width of the shared exponent is 8, the average number of bits required to store one value of the block is 8.125.

A memory space of a block floating-point format using an implicit bit according to an embodiment may follow Equation 5.

$${BFP}_{bit} = len ( s + m ) + \frac{len ( {e}_{s} )}{N} + \frac{⌈ {log}_{2} N ⌉ \times {N}_{max}}{N} \qquad [ Equation 5 ]$$

Referring to Equations 4 and 5, Nₘₐₓ is defined to be the number of values having a maximum exponent index. ┌log₂N┐×Nₘₐₓ is defined to be the number of bits per block, which is required to store the maximum exponent index. For example, when the bit-width of the sign-and-mantissa is 8, the block size of the block is 64, the bit-width of the shared exponent is 8, and the number of values having the maximum exponent index is 5, the average number of bits required to store one value of the block is 8.594.

According to an embodiment, even though 1 bit of an implicit bit may be further represented in the case following Equation 5 than in the case following Equation 4, only a memory space of about 0.469 bits is further used in the case following Equation 5 than in a block floating-point format following Equation 4. According to an embodiment, a memory space may be efficiently used even when higher precision is represented, or only a less memory space may be required even when the same precision is represented.

TABLE 1

| Block Size | 32 | 64 | 128 | 256 |
|---|---|---|---|---|
| BFP4 | 11.7 | 15.0 | 26.0 | 48.2 |
| BFP8 | 11.0 | 15.4 | 29.4 | 66.9 |
| BFP16 | 16.3 | 26.2 | 49.8 | 94.7 |

Referring to Table 1, Table 1 shows the number of bits per block required to store the maximum exponent index. Because the number of values having the maximum exponent is different for each data, the numerical values shown in Table 1 represent average numerical values. In BFPn, n represents the bit-width of the sign-and-mantissa. The mantissa includes only the bit-width of the explicit bits. For example, BFP4 may indicate the case where the bit-width of the sign-and-mantissa is 4 bits, BFP8 may indicate the case where the bit-width of the sign-and-mantissa is 8 bits, and BFP16 may indicate the case where the bit-width of the sign-and-mantissa is 16 bits. For example, when the block size is 32 and the BFP4 format is given, the average number of bits per block required to store the maximum exponent index may be about 11.7 bits. According to an embodiment, when the block size is 32, although a total of 32 bits may be secured as the implicit bit of the mantissa, only a memory space as much as about 11.7 bits rather than 32 bits may be used.

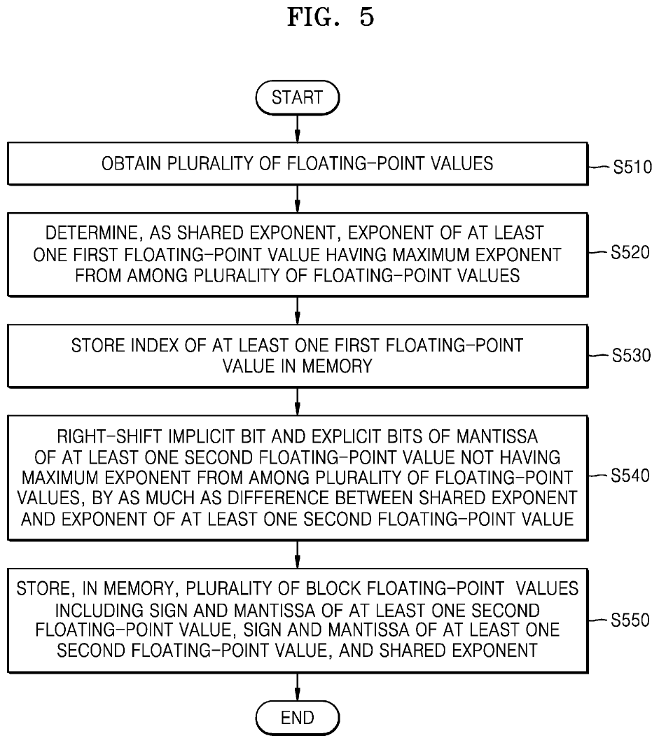

FIG. 5 is a flowchart illustrating a method of converting a floating-point value into a block floating-point value, according to an embodiment. Repeated descriptions given with reference to FIGS. 1 to 4 are omitted. For convenience of description, descriptions regarding FIG. 5 are made with reference to FIG. 3.

Referring to FIG. 5, the method of converting a floating-point value into a block floating-point value may include operations S510 to S550. In an embodiment, operations S510 to S550 may be performed by at least one of the electronic device 1000, the processor 1300 of the electronic device 1000, and the hardware accelerator 1400 of the electronic device 1000. However, the disclosure is not limited thereto, and operations S510 to S550 may be performed by any electronic device. The method of converting a floating-point value into a block floating-point value, according to an embodiment, is not limited to the example shown in FIG. 5 and may omit at least one of the operations shown in FIG. 5 or further include an operation not shown in FIG. 5.

In operation S510, the electronic device 1000 may obtain a plurality of floating-point values. For example, the electronic device 1000 may obtain a training dataset, input data for inference, and/or a parameter (for example, a weight value and/or a bias value) of an artificial intelligence model. The training dataset, the input data, and/or the parameter may be represented in a floating-point format. However, the disclosure is not limited thereto. The training dataset, the input data, and/or the parameter may be represented in various formats, and the electronic device 1000 may convert the training dataset, the input data, and/or the parameter into a floating-point format. The electronic device 1000 may obtain a plurality of floating-point values from the memory 1200 or from the internal memory of the hardware accelerator 1400. For example, the electronic device 1000 may obtain a plurality of floating-point values, which are output values of the processing core 1410. In an embodiment, the number of floating-point values may be predefined. The plurality of floating-point values may correspond to one block. One block may include a predefined number of floating-point values. The number of floating-point values, which are included in one block, may also be referred to as a block size. For example, when the block size is 256, one block may include 256 floating-point values.

In operation S520, the electronic device 1000 may determine, as a shared exponent, the exponent of at least one first floating-point value having a maximum exponent, from among the plurality of floating-point values. The electronic device 1000 may identify a value (for example, a first floating-point value) having the maximum exponent, from among the plurality of floating-point values corresponding to one block. The electronic device 1000 may identify the exponent of the identified value. The electronic device 1000 may determine the identified exponent to be the shared exponent of the block.

In operation S530, the electronic device 1000 may store the index of the at least one first floating-point value in the memory 1200. For example, the plurality of floating-point values may each have an index corresponding thereto. The electronic device 1000 may store, in the memory 1200, an index corresponding to the at least one first floating-point value having the same exponent as the shared exponent, from among the plurality of floating-point values.

In operation S540, the electronic device 1000 may right-shift an implicit bit and explicit bits of a mantissa of at least one second floating-point value not having the maximum exponent, from among the plurality of floating-point values, by as much as the difference between the shared exponent and the exponent of the at least one second floating-point value. In an embodiment, an implicit bit before shifting may be represented as an explicit bit after shifting. In an embodiment, the shifted implicit bit of the mantissa of the second floating-point value may be interpreted as “0”.

In operation S550, the electronic device 1000 may store, in the memory 1200, a plurality of block floating-point values, which include the sign and the mantissa of the at least one first floating-point value, the sign and the mantissa of the at least one second floating-point value, and the shared exponent. In an embodiment, the explicit bit of the mantissa is stored in the memory 1200 and the implicit bit thereof is not stored in the memory 1200. In an embodiment, a first implicit bit of the mantissa of the first floating-point value may have a first value (for example, “1”). In an embodiment, a second implicit bit of the mantissa of the second floating-point value may have a second value (for example, “0”). In an embodiment, the implicit bit of the mantissa of the first floating-point value may be interpreted as “1” and the implicit bit of the mantissa of the second floating-point value may be interpreted as “0”.

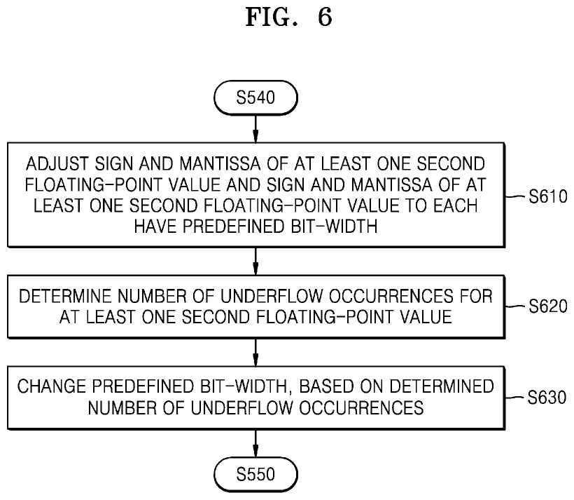

FIG. 6 is a flowchart illustrating a method of changing a bit-width or precision, according to an embodiment. Repeated descriptions given with reference to FIGS. 1 to 5 are omitted. For convenience of description, descriptions regarding FIG. 6 are made with reference to FIGS. 3 and 5.

Referring to FIG. 6, the method of changing a bit-width or precision may include operations S610 to S630. In an embodiment, operations S610 to S630 may be performed by at least one of the electronic device 1000, the processor 1300 of the electronic device 1000, and the hardware accelerator 1400 of the electronic device 1000. However, the disclosure is not limited thereto, and operations S610 to S630 may be performed by any electronic device. The method of changing a bit-width or precision, according to an embodiment, is not limited to the example shown in FIG. 6 and may omit at least one of the operations shown in FIG. 6 or further include an operation not shown in FIG. 6.

In an embodiment, the method of converting a floating-point value into a block floating-point value in FIG. 5 may include operations S610 to S630 corresponding to the method of changing a bit-width or precision. After operation S540, the procedure may move to operation S610.

In operation S610, the electronic device 1000 may adjust the sign-and-mantissa of the at least one first floating-point value and the sign-and-mantissa of the at least one second floating-point value to each have a predefined bit-width. The predefined bit-width may be different depending on settings by a user or a manufacturer. For example, it is assumed that, in each of the first floating-point value and the second floating-point value, the sign has a bit-width of 1 bit, the mantissa has a bit-width of 7 bits, and the predefined bit-width is 4 bits. In the predefined bit-width, 1 bit may correspond to the sign and 3 bits may correspond to the mantissa. Right 4 bits of the mantissa of the first floating-point value and right 4 bits of the second floating-point value that is right-shifted may be discarded.

In operation S620, the electronic device 1000 may determine the number of underflow occurrences for the at least one second floating-point value. The at least one second floating-point value may be right-shifted and/or adjusted to have the predefined bit-width, and thus, underflow in which all the bits of the mantissa have a value of “0” may occur. In an embodiment, the electronic device 1000 may determine the number of underflow occurrences in the process of a training operation of an artificial intelligence model. The plurality of floating-point values may correspond to a training dataset (for example, an input value) and/or a parameter (for example, a weight value and/or a bias value) of at least one layer. The electronic device 1000 may determine the number of underflow occurrences for the at least one second floating-point value during a predefined training unit. For example, the predefined training unit may include at least one of a batch size (which may be alternatively referred to as the number of mini-batches), an epoch, and an iteration. For example, it is assumed that the predefined training unit is a batch size and the batch size is 100. The electronic device 1000 may count the number of underflow occurrences while a training operation is performed on 100 mini-batches. The electronic device 1000 may determine the number of underflow occurrences based on a counting result.

In operation S630, the electronic device 1000 may change the predefined bit-width, based on the determined number of underflow occurrences. The predefined bit-width may indicate a bit-width of a sign-and-mantissa of a block floating-point value. For example, when the predefined bit-width is 4 bits, the bit-width of the sign-and-mantissa of the first block floating-point value and/or the second block floating-point value may be 4 bits. Here, the predefined bit-width may be a representation excluding an implicit bit of the mantissa. The electronic device 1000 may determine whether the determined number of underflow occurrences exceeds a critical range. The electronic device 1000 may change the predefined bit-width to a bit-width that is greater or less than the predefined bit-width, in response to determining that the determined number of underflow occurrences exceeds the critical range. After operation S630, the procedure moves to operation S550.

In an embodiment, after operation S550, the procedure moves to operation S510, and the electronic device 1000 may repeat an operation of converting a floating-point value for the next training unit into a block floating-point value. In operation S610, the first floating-point value and the second floating-point value may each be adjusted to have the changed bit-width. For example, it is assumed that the predefined training unit is a batch size and the batch size is 100. The electronic device 1000 may perform operations corresponding to operations S510 to S550 and S610 to S630 when performing training on the next 100 mini-batches.

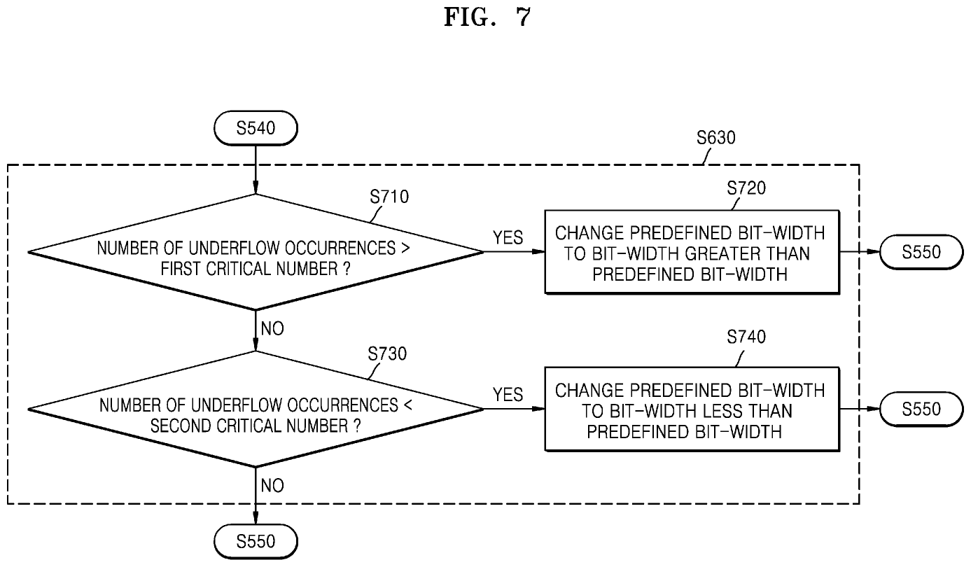

FIG. 7 is a flowchart illustrating detailed operations of operation S630 of FIG. 6. Repeated descriptions given with reference to FIGS. 1 to 6 are omitted. For convenience of description, descriptions regarding FIG. 7 are made with reference to FIGS. 3, 5, and 6.

Referring to FIG. 7, operation S630 of FIG. 6 may include operations S710 to S740. In an embodiment, operations S710 to S740 may be performed by at least one of the electronic device 1000, the processor 1300 of the electronic device 1000, and the hardware accelerator 1400 of the electronic device 1000. However, the disclosure is not limited thereto, and operations S710 to S740 may be performed by any electronic device. The detailed operations of operation S630 according to an embodiment are not limited to the example shown in FIG. 7 and may omit at least one of the operations shown in FIG. 7 or further include an operation not shown in FIG. 7.

In operation S710, the electronic device 1000 may determine whether the number of underflow occurrences is greater than a first critical number. The first critical number may be predefined depending on settings by a user or a manufacturer. The procedure moves to operation S720 in response to determining that the number of underflow occurrences is greater than the first critical number (that is, “YES”). The procedure moves to operation S730 in response to determining that the number of underflow occurrences is not greater than the first critical number (that is, “NO”).

In operation S720, the electronic device 1000 may change the predefined bit-width to a bit-width greater than the predefined bit-width. For example, when the current bit-width is 4 bits, the electronic device 1000 may change the next bit-width to 8 bits. However, the disclosure is not limited thereto, and the electronic device 1000 may change the predefined bit-width to a bit-width having any integer value greater than 4 bits. After operation S720, the procedure moves to operation S550.

In operation S730, the electronic device 1000 may determine whether the number of underflow occurrences is less than a second critical number. The second critical number may be predefined depending on settings by a user or a manufacturer. The procedure moves to operation S740 in response to determining that the number of underflow occurrences is less than the second critical number (that is, “YES”). The procedure moves to operation S550 in response to determining that the number of underflow occurrences is not less than the second critical number (that is, “NO”).

In operation S740, the electronic device 1000 may change the predefined bit-width to a bit-width less than the predefined bit-width. For example, when the current bit-width is 16 bits, the electronic device 1000 may change the next bit-width to 8 bits. However, the disclosure is not limited thereto, and the electronic device 1000 may change the predefined bit-width to a bit-width having any integer value less than 16 bits. After operation S740, the procedure moves to operation S550.

According to an embodiment, the bit-width of the sign-and-mantissa may be changed for each predefined training unit, thereby adaptively improving a learning rate or training accuracy depending on characteristics of data.

In an embodiment, unlike the example shown in FIG. 7, operation S730 may be performed earlier than operation S710. For example, it may be determined first whether the number of underflow occurrences is less than the second critical number, and then, it may be determined whether the number of underflow occurrences is greater than the first critical number.

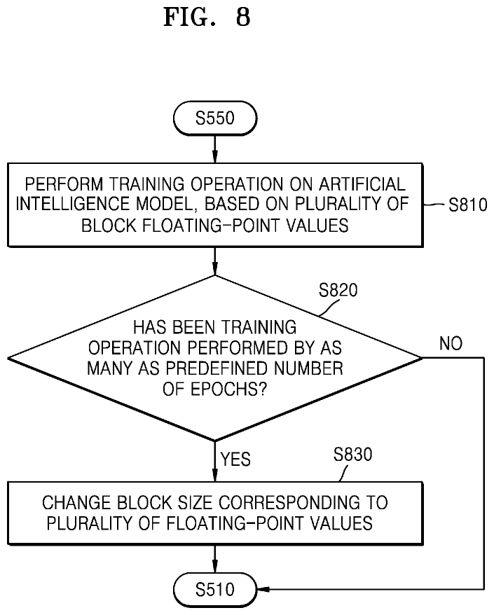

FIG. 8 is a flowchart illustrating a method of changing a block size, according to an embodiment. Repeated descriptions given with reference to FIGS. 1 to 7 are omitted. For convenience of description, descriptions regarding FIG. 8 are made with reference to FIGS. 3 and 5.

Referring to FIG. 8, the method of changing a block size may include operations S810 to S830. In an embodiment, operations S810 to S830 may be performed by at least one of the electronic device 1000, the processor 1300 of the electronic device 1000, and the hardware accelerator 1400 of the electronic device 1000. However, the disclosure is not limited thereto, and operations S810 to S830 may be performed by any electronic device. The method of changing a block size, according to an embodiment, is not limited to the example shown in FIG. 8 and may omit at least one of the operations shown in FIG. 8 or further include an operation not shown in FIG. 8.

In an embodiment, the method of converting a floating-point value into a block floating-point value in FIG. 5 may include operations S810 to S830 corresponding to the method of changing a block size. After operation S550, the procedure may move to operation S810.

In operation S810, the electronic device 1000 may perform a training operation on an artificial intelligence model, based on a plurality of block floating-point values. For example, the plurality of block floating-point values may include at least one of an input value and a weight value. In an embodiment, the electronic device 1000 may perform a MAC operation between an input value and a weight value.

In operation S820, the electronic device 1000 may determine whether the training operation has been performed by as many as a predetermined number of epochs. Herein, the epoch may indicate one cycle in which parameters of the artificial intelligence model are updated by causing all training datasets to pass through the artificial intelligence model. When the training operation has not been performed by as many as the predetermined number of epochs, the block size is not changed and the procedure moves to operation S510.

In operation S830, the electronic device 1000 may change the block size corresponding to a plurality of floating-point values, in response to determining that the training operation has been performed by as many as the predetermined number of epochs. For example, the plurality of floating-point values may be respectively converted into a plurality of block floating-point values having a first block size. When the training operation has been performed by as many as the predetermined number of epochs, a plurality of floating-point values to be obtained in the next epoch may be converted into a plurality of block floating-point values having a second block size. The second block size may be greater than the first block size. In an embodiment, the predetermined number of epochs may be different depending on settings by a user or a manufacturer.

In an embodiment, when the predetermined number of epochs using a learning rate decay technique has been performed during a training process of the artificial intelligence model, the block size corresponding to the plurality of floating-point values may be changed.

According to an embodiment, by adaptively increasing the block size, a data size or a memory space, which is required for training, may be significantly reduced. According to an embodiment, by adaptively increasing the block size, the energy consumption of a hardware accelerator, which is required for training, may be significantly reduced.

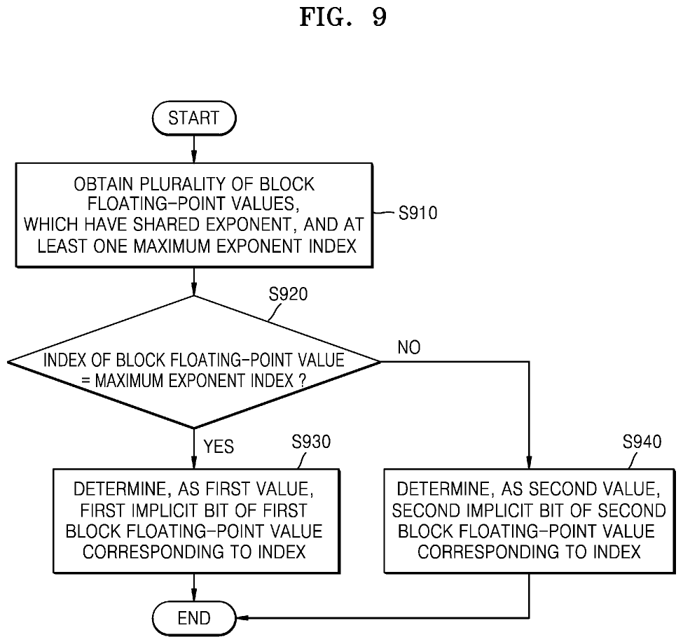

FIG. 9 is a flowchart illustrating a method of processing a block floating-point value, according to an embodiment. Repeated descriptions given with reference to FIGS. 1 to 8 are omitted. For convenience of description, descriptions regarding FIG. 9 are made with reference to FIG. 3.

Referring to FIG. 9, the method of processing a block floating-point value may include operations S910 to S940. In an embodiment, operations S910 to S940 may be performed by at least one of the electronic device 1000, the processor 1300 of the electronic device 1000, and the hardware accelerator 1400 of the electronic device 1000.

However, the disclosure is not limited thereto, and operations S910 to S940 may be performed by any electronic device. The method of processing a block floating-point value, according to an embodiment, is not limited to the example shown in FIG. 9 and may omit at least one of the operations shown in FIG. 9 or further include an operation not shown in FIG. 9.

In operation S910, the electronic device 1000 may obtain a plurality of block floating-point values, which have a shared exponent, and at least one maximum exponent index. In an embodiment, the plurality of block floating-point values may include at least one first block floating-point value and at least one second block floating-point value. In an embodiment, the electronic device 1000 may load a shared exponent of a block, a sign and a mantissa of each of the plurality of block floating-point values, and a maximum exponent index list, which are stored in the memory 1200. The electronic device 1000 may obtain at least one maximum exponent index from the maximum exponent index list.

In operation S920, the electronic device 1000 may determine whether the index of each of the plurality of block floating-point values corresponds to the at least one maximum exponent index. In an embodiment, the electronic device 1000 may identify a block floating-point value mapped to the at least one maximum exponent index. When the index of the block floating-point value corresponds to the maximum exponent index, the procedure moves to operation S930. When the index of the block floating-point value does not correspond to the maximum exponent index, the procedure moves to operation S940.

In operation S930, the electronic device 1000 may determine, as a first value, a first implicit bit of the first block floating-point value corresponding to the index. For example, the first value may be “1”. For example, the exponent of the first block floating-point value may be equal to the shared exponent.

In operation S940, the electronic device 1000 may determine, as a second value, a second implicit bit of the second block floating-point value corresponding to the index. For example, the second value may be “0”. For example, the exponent of the second block floating-point value may be less than the shared exponent.

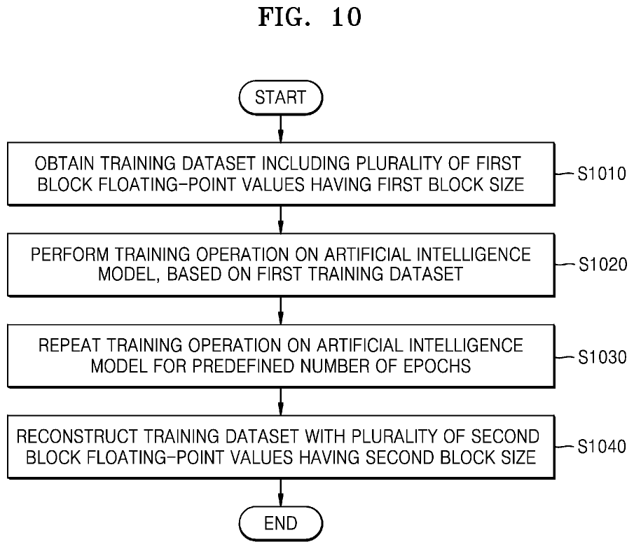

FIG. 10 is a flowchart illustrating a method of training an artificial intelligence model by using a hardware accelerator, according to an embodiment. Repeated descriptions given with reference to FIGS. 1 to 9 are omitted. For convenience of description, descriptions regarding FIG. 10 are made with reference to FIG. 3.

Referring to FIG. 10, the method of training an artificial intelligence model by using a hardware accelerator may include operations S1010 to S1040. In an embodiment, operations S1010 to S1040 may be performed by at least one of the electronic device 1000, the processor 1300 of the electronic device 1000, and the hardware accelerator 1400 of the electronic device 1000. However, the disclosure is not limited thereto, and operations S1010 to S1040 may be performed by any electronic device. The method of training an artificial intelligence model by using a hardware accelerator, according to an embodiment, is not limited to the example shown in FIG. 10 and may omit at least one of the operations shown in FIG. 10 or further include an operation not shown in FIG. 10.

In operation S1010, the electronic device 1000 may obtain a training dataset including a plurality of first block floating-point values having a first block size.

In operation S1020, the electronic device 1000 may perform a training operation on an artificial intelligence model, based on the training dataset. In an embodiment, the artificial intelligence model may include at least one layer. The at least one layer may include at least one weight value. The training dataset may include at least one input value. In the disclosure, the training operation may include a forward pass operation, a backward pass operation, and a weight update operation, which are performed through a multiplication operation between the input value and the weight value. For example, the forward pass operation is a process of calculating the loss of a training process, and the backward pass operation is a process of calculating a gradient for a loss function. The gradient is obtained generally by a chain rule and propagated to all layers constituting the artificial intelligence model in an opposite direction to that of the forward pass operation. The weight update operation is a process of updating weight values of the artificial intelligence model, and in the weight update operation, an existing weight value is updated by subtracting, from the existing weight value, a value obtained by multiplying the gradient of the loss function for the weight value by a learning rate.

In operation S1030, the electronic device 1000 may repeat the training operation on the artificial intelligence model for a predefined number of epochs. After the training operation is repeated for the predefined number of epochs, the procedure moves to operation S1040.

In operation S1040, the electronic device 1000 may reconstruct the training dataset with a plurality of second block floating-point values having a second block size. In an embodiment, the electronic device 1000 may obtain a plurality of floating-point values corresponding to at least a portion of the training dataset. The electronic device 1000 may respectively convert the plurality of floating-point values into block floating-point values having a second block size. In an embodiment, the second block size may be greater than the first block size.

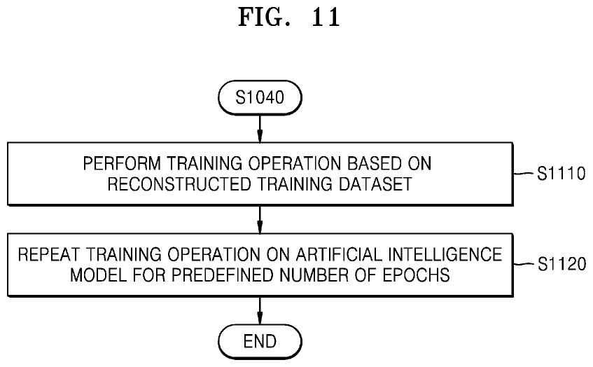

FIG. 11 is a flowchart illustrating a method of training an artificial intelligence model by using a hardware accelerator, according to an embodiment. Repeated descriptions given with reference to FIGS. 1 to 10 are omitted. For convenience of description, descriptions regarding FIG. 11 are made with reference to FIGS. 3 and 10.

Referring to FIG. 11, the method of training an artificial intelligence model by using a hardware accelerator may include operations S1110 and S1120 in addition to operations S1010 to S1040. In an embodiment, operations S1110 and S1120 may be performed by at least one of the electronic device 1000, the processor 1300 of the electronic device 1000, and the hardware accelerator 1400 of the electronic device 1000. However, the disclosure is not limited thereto, and operations S1110 and S1120 may be performed by any electronic device. The method of training an artificial intelligence model by using a hardware accelerator, according to an embodiment, is not limited to the example shown in FIG. 11 and may omit at least one of the operations shown in FIG. 11 or further include an operation not shown in FIG. 11.

In operation S1110, the electronic device 1000 may perform a training operation based on a reconstructed training dataset. Operation S1110 may correspond to operation S1020 of FIG. 10.

In operation S1120, the electronic device 1000 may repeat the training operation on the artificial intelligence model for a predefined number of epochs. Operation S1120 may correspond to operation S1030 of FIG. 10. In an embodiment, the electronic device 1000 may reconstruct the training dataset with a plurality of second block floating-point values having a third block size. In an embodiment, the third block size may be greater than the second block size.

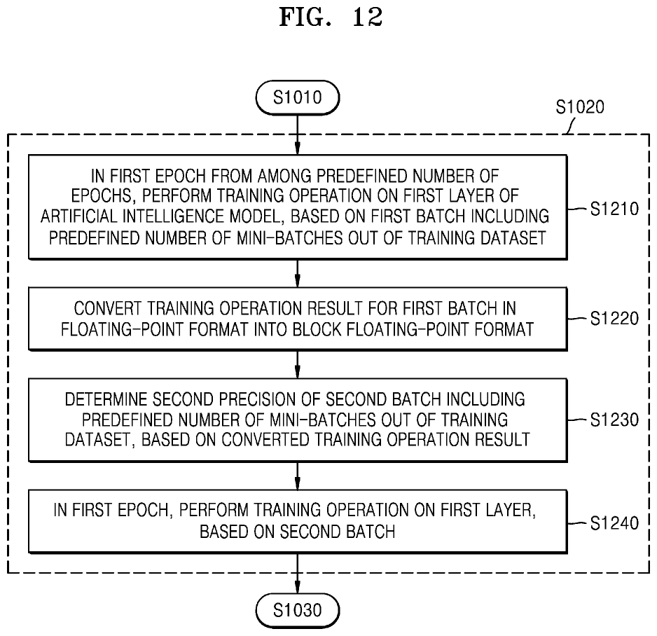

FIG. 12 is a flowchart illustrating detailed operations of operation S1020 of FIG. 10. Repeated descriptions given with reference to FIGS. 1 to 11 are omitted. For convenience of description, descriptions regarding FIG. 12 are made with reference to FIGS. 3 and 10.

Referring to FIG. 12, operation S1020 of FIG. 10 may include operations S1210 to S1240. In an embodiment, operations S1210 to S1240 may be performed by at least one of the electronic device 1000, the processor 1300 of the electronic device 1000, and the hardware accelerator 1400 of the electronic device 1000. However, the disclosure is not limited thereto, and operations S1210 to S1240 may be performed by any electronic device. The detailed operations of operation S1020 according to an embodiment are not limited to the example shown in FIG. 12 and may omit at least one of the operations shown in FIG. 12 or further include an operation not shown in FIG. 12.

In operation S1210, the electronic device 1000 may perform, in a first epoch from among a predefined number of epochs, a training operation on a first layer of the artificial intelligence model, based on a first batch including a predefined number of mini-batches out of the training dataset. In an embodiment, the first batch may have first precision. For example, the first batch may include block floating-point values having the first precision. The electronic device 1000 may perform the training operation in a first precision environment. In an embodiment, the artificial intelligence model may include a plurality of layers. For example, the first layer may be one of the plurality of layers.

In operation S1220, the electronic device 1000 may convert a result of the training operation on the first batch into a block floating-point format. In an embodiment, the result of the training operation on the first batch may be represented in a floating-point format.

In operation S1230, the electronic device 1000 may determine second precision of a second batch including a predefined number of mini-batches out of the training dataset, based on the converted result of the training operation. In an embodiment, the electronic device 1000 may determine the second precision of the second batch, based on the number of underflow occurrences for the first batch.

In operation S1240, the electronic device 1000 may perform, in the first epoch, a training operation on the first layer based on the second batch. The electronic device 1000 may perform the training operation in a second precision environment. In an embodiment, the first batch and the second batch may be different data groups undergoing an operation in one epoch. For example, the second batch may include mini-batches subsequently input to the artificial intelligence model after the mini-batches of the first batch.

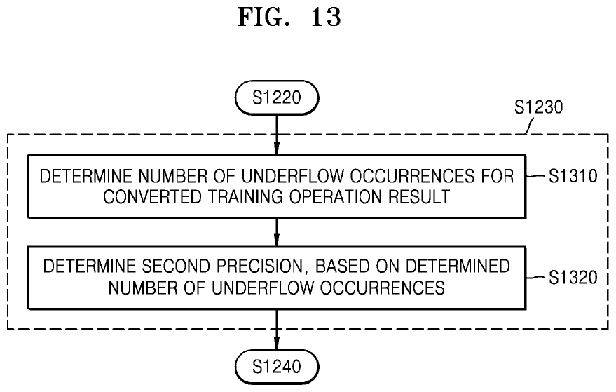

FIG. 13 is a flowchart illustrating detailed operations of operation S1230 of FIG. 12. Repeated descriptions given with reference to FIGS. 1 to 12 are omitted. For convenience of description, descriptions regarding FIG. 13 are made with reference to FIGS. 3, 10, and 12.

Referring to FIG. 13, operation S1230 of FIG. 12 may include operations S1310 and 1320. In an embodiment, operations S1310 and 1320 may be performed by at least one of the electronic device 1000, the processor 1300 of the electronic device 1000, and the hardware accelerator 1400 of the electronic device 1000. However, the disclosure is not limited thereto, and operations S1310 and 1320 may be performed by any electronic device. The detailed operations of operation S1230 according to an embodiment are not limited to the example shown in FIG. 13 and may omit at least one of the operations shown in FIG. 13 or further include an operation not shown in FIG. 13.

In operation S1310, the electronic device 1000 may determine the number of underflow occurrences for the converted result of the training operation. The electronic device 1000 may count the number of underflow occurrences while a training operation is performed on one layer (for example, a second layer) based on one batch (for example, a first batch) including a predefined number of mini-batches.

In operation S1320, the electronic device 1000 may determine second precision for values corresponding to parameters of one layer (for example, the first layer) and/or one batch (for example, the second batch) including the predefined number of mini-batches that are to be input next time, based on the determined number of underflow occurrences. In an embodiment, the electronic device 1000 may determine the second precision to be greater or less than the first precision, based on the determined number of underflow occurrences.

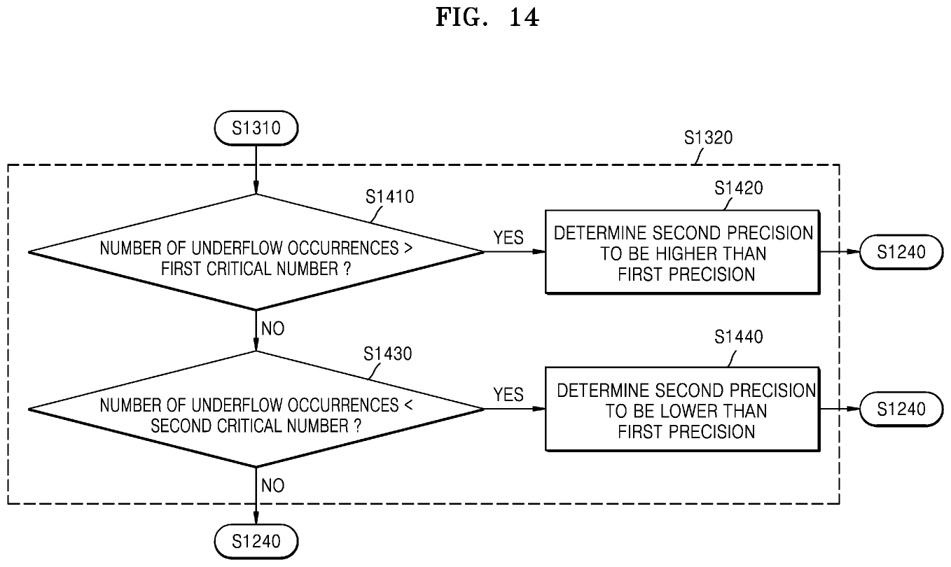

FIG. 14 is a flowchart illustrating detailed operations of operation S1320 of FIG. 13. Repeated descriptions given with reference to FIGS. 1 to 13 are omitted. For convenience of description, descriptions regarding FIG. 14 are made with reference to FIGS. 3, 10, 12, and 13.

Referring to FIG. 14, operation S1320 of FIG. 13 may include operations S1410 to S1440. In an embodiment, operations S1410 to S1440 may be performed by at least one of the electronic device 1000, the processor 1300 of the electronic device 1000, and the hardware accelerator 1400 of the electronic device 1000. However, the disclosure is not limited thereto, and operations S1410 to S1440 may be performed by any electronic device. The detailed operations of operation S1320 according to an embodiment are not limited to the example shown in FIG. 14 and may omit at least one of the operations shown in FIG. 14 or further include an operation not shown in FIG. 14.

In operation S1410, the electronic device 1000 may determine whether the number of underflow occurrences is greater than a first critical number. The first critical number may be predefined depending on settings by a user or a manufacturer. The procedure moves to operation S1420 in response to determining that the number of underflow occurrences is greater than the first critical number (that is, “YES”). The procedure moves to operation S1430 in response to determining that the number of underflow occurrences is not greater than the first critical number (that is, “NO”).

In operation S1420, the electronic device 1000 may determine the second precision to be higher than the first precision. For example, when the first precision is 4, although the electronic device 1000 may determine the second precision to be 8, the disclosure is not limited thereto, and the electronic device 1000 may determine the second precision to be any integer value greater than 4. After operation S1420, the procedure moves to operation S1240.

In operation S1430, the electronic device 1000 may determine whether the number of underflow occurrences is less than a second critical number. The second critical number may be predefined depending on settings by a user or a manufacturer. The procedure moves to operation S1440 in response to determining that the number of underflow occurrences is less than the second critical number (that is, “YES”). The procedure moves to operation S1240 in response to determining that the number of occurrences of underflow is not less than the second critical number (that is, “NO”).

In operation S1440, the electronic device 1000 may determine the second precision to be lower than the first precision. For example, when the first precision is 16, although the electronic device 1000 may determine the second precision to be 8, the disclosure is not limited thereto, and the electronic device 1000 may determine the second precision to be any integer value less than 16. After operation S1440, the procedure moves to operation S1240.

In an embodiment, unlike the example shown in FIG. 14, operation S1430 may be performed earlier than operation S1410. For example, it may be determined first whether the number of underflow occurrences is less than the second critical number, and then, it may be determined next whether the number of underflow occurrences is greater than the first critical number.

FIG. 15 is a block diagram illustrating a configuration of a hardware accelerator according to an embodiment. The configuration, functions, and operations of the hardware accelerator 1400 of FIG. 15 may respectively correspond to the configuration, functions, and operations of the hardware accelerator 1400 of FIG. 3. Repeated descriptions given with reference to FIGS. 1 to 14 are omitted.

Referring to FIG. 15, the hardware accelerator 1400 may include a processing core 1410, an FP2BFP converter 1420, an output buffer 1430, a batch normalizer 1440, and an activation function and pooling module 1450.

The processing core 1410 may include a plurality of sub-cores 1411 and a selective adder tree 1412. Although FIG. 15 illustrates that the processing core 1410 includes 4 sub-cores, the disclosure is not limited thereto. In an embodiment, the processing core 1410 may include a first sub-core 1411_1 (which may also be referred to as Sub-core 0), a second sub-core 1411_2 (which may also be referred to as Sub-core 1), a third sub-core 1411_3 (which may also be referred to as Sub-core 2), a fourth sub-core 1411_4 (which may also be referred to as Sub-core 3), and the selective adder tree 1412.

Each of the first to fourth sub-cores 1411_1 to 1411_4 may include a plurality of PEs. Each of the first to fourth sub-cores 1411_1 to 1411_4 may transfer operation result values to the selective adder tree 1412 through a plurality of output ports. The operation result values of the first to fourth sub-cores 1411_1 to 1411_4 may be added up by the selective adder tree 1412. Although not shown, the selective adder tree 1412 may receive an exponent multiplication result value between shared exponents. The selective adder tree 1412 may output a floating-point value based on the exponent multiplication result value and on the operation result values of the first to fourth sub-cores 1411_1 to 1411_4. The selective adder tree 1412 may transfer the floating-point value to the output buffer 1430.

Each of the first to fourth sub-cores 1411_1 to 1411_4 may perform a predetermined number of MAC operations having predefined precision for one cycle. For example, each of the first to fourth sub-cores 1411_1 to 1411_4 may perform 128 INT4 MAC operations for one cycle, but the disclosure is not limited thereto.

The output buffer 1430 may receive data that is output from the processing core 1410. The output buffer 1430 may store data that is output from the processing core 1410. The output buffer 1430 may transfer data, which is output from the processing core 1410, to the batch normalizer 1440. In an embodiment, the output buffer 1430 may queue data that is output from the processing core 1410. When a predefined-size queue of the output buffer 1430 is full, the output buffer 1430 may transfer the queued data to the batch normalizer 1440. In an embodiment, the output buffer 1430 may be configured as at least a portion of the internal memory of the hardware accelerator 1400.

The batch normalizer 1440 may perform batch normalization. The batch normalizer 1440 may perform batch normalization based on an output of the output buffer 1430. In an embodiment, the batch normalization is a processing method used to find weight parameters with faster convergence and allows a training process to be more stably performed by reducing an internal covariant shift.

The activation function and pooling module 1450 may apply an activation function and perform a pooling operation, based on an output of the batch normalizer 1440. In an embodiment, the activation function and pooling module 1450 may include a first logic circuit for implementing an activation function and a second logic circuit for implementing a pooling operation.

Although the activation function may be any activation function, such as ReLU, sigmoid, tanh, leaky ReLU, PreLU, ELU, or SELU, the disclosure is not limited thereto, and the activation function may be different depending on settings by a user or a manufacturer.

Herein, pooling refers to an operation of reducing a spatial dimension of input data by performing screening (or extraction) on the input data according to predefined criteria. The pooling may also be referred to as subsampling or downsampling. For example, although the pooling may be any pooling, such as max pooling and/or average pooling, the disclosure is not limited thereto, and the pooling may be different depending settings by a user or a manufacturer. Herein, the max pooling refers to an operation of extracting a maximum value from input data, and the average pooling refers to an operation of extracting an average value from input data.

The FP2BFP converter 1420 may convert values in a floating-point format into values in a block floating-point format, based on an output of the activation function and pooling module 1450. Each of the output of the processing core 1410, the output of the output buffer 1430, the output of the batch normalizer 1440, and the output of the activation function and pooling module 1450 may be represented by values in a floating-point format. The FP2BFP converter 1420 may store the converted values in a block floating-point format in the memory 1200. The FP2BFP converter 1420 may count the number of underflow occurrences during the conversion process.

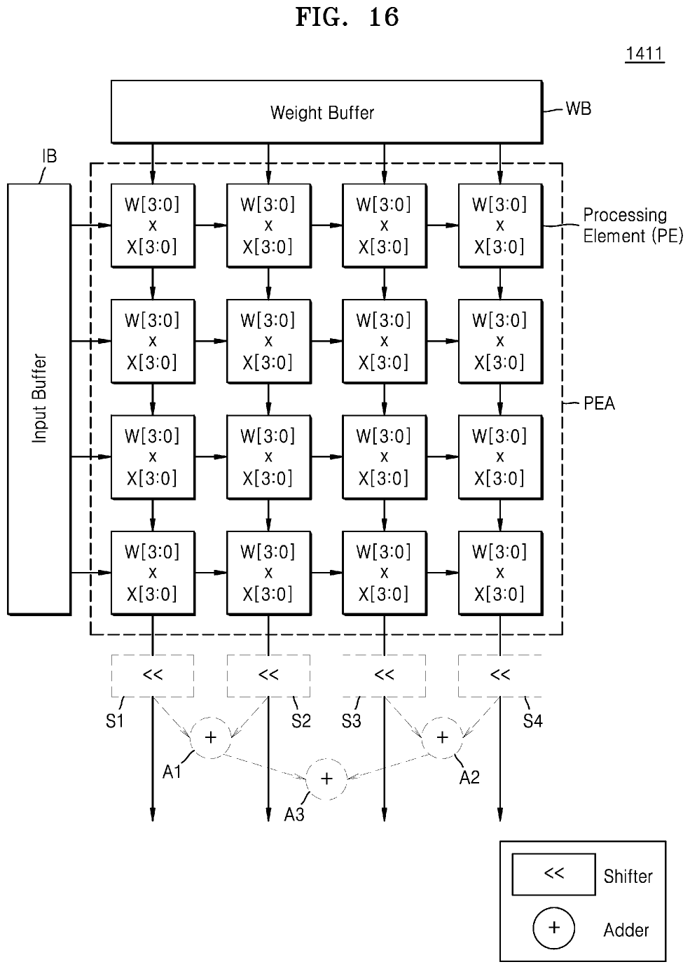

FIG. 16 is a block diagram illustrating examples of a configuration and operations of a sub-core according to an embodiment. The configuration, functions, and operations of the processing core 1410 of FIG. 16 may respectively correspond to the configuration, functions, and operations of the processing core 1410 of FIGS. 3 and 15. Repeated descriptions given with reference to FIGS. 1 to 15 are omitted.

Referring to FIG. 16, the sub-core 1411 may include a PE array PEA, an input buffer IB, a weight buffer WB, a plurality of shifters, and a plurality of adders.

The PE array PEA may include a plurality of PEs. Although FIG. 15 illustrates that the PE array PEA includes 16 PEs, the number of PEs in the PE array PEA is not limited thereto. Each of the PEs may include at least one multiplier. The multiplier may support signed operations and/or unsigned operations. In an embodiment, although the multiplier may include a 4-bit multiplier, the disclosure is not limited thereto, and the multiplier may be any multiplier capable of processing signs and mantissas having various precisions. For example, the multiplier may perform multiplication by using a 4-bit input value and a 4-bit weight value as operands.

In an embodiment, the plurality of PEs may be grouped with various numbers (for example, 2, 4, 6, 8, 16, and the like) and in various manners (for example, 1×1, 2×2, 2×1, 4×4, 4×2, and the like) to support various precisions.

The input buffer IB may receive an input value (which may be alternatively referred to as input data, an input feature map, an input tensor, or the like). The input buffer IB may transmit the input value to the PE array PEA. The weight buffer WB may receive a weight value (which may be alternatively referred to as weight data, a weight kernel, a weight tensor, or the like). The weight buffer WB may transmit the weight value to the PE array PEA. In an embodiment, the input buffer IB and the weight buffer WB may each be configured as at least a portion of the internal memory of the hardware accelerator 1400.

Each of the plurality of shifters may perform shifting on bits that are input thereto. For example, although the following description is made under the assumption that each of the plurality of shifters performs left-shifting, the disclosure is not limited thereto, and each of the plurality of shifters may perform right-shifting. Each of the plurality of shifters may perform left-shifting by as much as any number of bits, for example, 4 bits to 12 bits. Each of the plurality of shifters may be activated or deactivated in response to a control signal transferred by the processor 1300 and/or the hardware accelerator 1400.

Each of the plurality of adders may perform a summation operation on bits that are input thereto. Each of the plurality of adders may be implemented by an integer adder, but the disclosure is not limited thereto. Each of the plurality of adders may be activated or deactivated in response to a control signal transferred by the processor 1300 and/or the hardware accelerator 1400.

In an embodiment, 4 PEs may be connected to 4 shifters and 3 adders. Here, the 4 PEs may be arranged in a 1×4 form, that is, in one row and four columns. For example, a first PE may be connected with a first shifter S1. When the first shifter S1 is activated, an output value of the first PE may pass through the first shifter S1 that is activated. The first shifter S1 may shift the output value by as much as a predefined number of bits. When the first shifter S1 is not activated, the output value of the first PE may be transferred to a first adder A1 or the selective adder tree 1412. When the first adder A1 is activated, the output value having passed through the first shifter S1 may pass through the first adder A1. When the first adder A1 is not activated, the output value having passed through the first shifter S1 may be transferred to the selective adder tree 1412.

A second PE may be connected with a second shifter S2. When the second shifter S2 is activated, an output value of the second PE may pass through the second shifter S2 that is activated. The second shifter S2 may shift the output value by as much as a predefined number of bits. When the second shifter S2 is not activated, the output value of the second PE may be transferred to the first adder A1 or the selective adder tree 1412. When the first adder A1 is activated, the output value having passed through the second shifter S2 may pass through the first adder A1. When the first adder A1 is not activated, the output value having passed through the second shifter S2 may be transferred to the selective adder tree 1412. The first adder A1 may add the output value (or the shifted output value) of the second PE to the output value (or the shifted output value) of the first PE. The output value having passed through the activated first adder A1 may be transferred to a third adder A3 or the selective adder tree 1412.

A third PE may be connected with a third shifter S3. When the third shifter S3 is activated, an output value of the third PE may pass through the third shifter S3 that is activated. The third shifter S3 may shift the output value by as much as a predefined number of bits. When the third shifter S3 is not activated, the output value of the third PE may be transferred to the second adder A2 or the selective adder tree 1412. When the second adder A2 is activated, the output value having passed through the third shifter S3 may pass through the second adder A2. When the second adder A2 is not activated, the output value having passed through the third shifter S3 may be transferred to the selective adder tree 1412.

A fourth PE may be connected with a fourth shifter S4. When the fourth shifter S4 is activated, an output value of the fourth PE may pass through the fourth shifter S4 that is activated. The fourth shifter S4 may shift the output value by as much as a predefined number of bits. When the fourth shifter S4 is not activated, the output value of the fourth PE may be transferred to the second adder A2 or the selective adder tree 1412. When the second adder A2 is activated, the output value having passed through the fourth shifter S4 may pass through the second adder A2. When the second adder A2 is not activated, the output value having passed through the fourth shifter S4 may be transferred to the selective adder tree 1412. The second adder A2 may add the output value (or the shifted output value) of the fourth PE to the output value (or the shifted output value) of the third PE. The output value having passed through the activated second adder A2 may be transferred to the third adder A3 or the selective adder tree 1412. When the third adder A3 is activated, the third adder A3 may add an output value of the second adder A2 to an output value of the first adder A1. The output value having passed through the activated third adder A3 may be transferred to the selective adder tree 1412.

In FIGS. 16 to 18, shifters and/or adders indicated by dashed lines represent that the shifters and/or the adders are deactivated, and shifters and/or adders indicated by solid lines represent that the shifters and/or the adders are activated.

For example, FIG. 16 illustrates operations of the sub-core 1411 when an input value and a weight value each include 4 bits. Each of the PEs may perform a multiplication operation between a 4-bit weight value W[3:0] and a 4-bit input value X[3:0]. Each of the PEs may transfer a multiplication operation result to the selective adder tree 1412. In an embodiment, the plurality of shifters and the plurality of adders may not be activated. The processor 1300 and/or the hardware accelerator 1400 may control the plurality of shifters and the plurality of adders not to be activated.

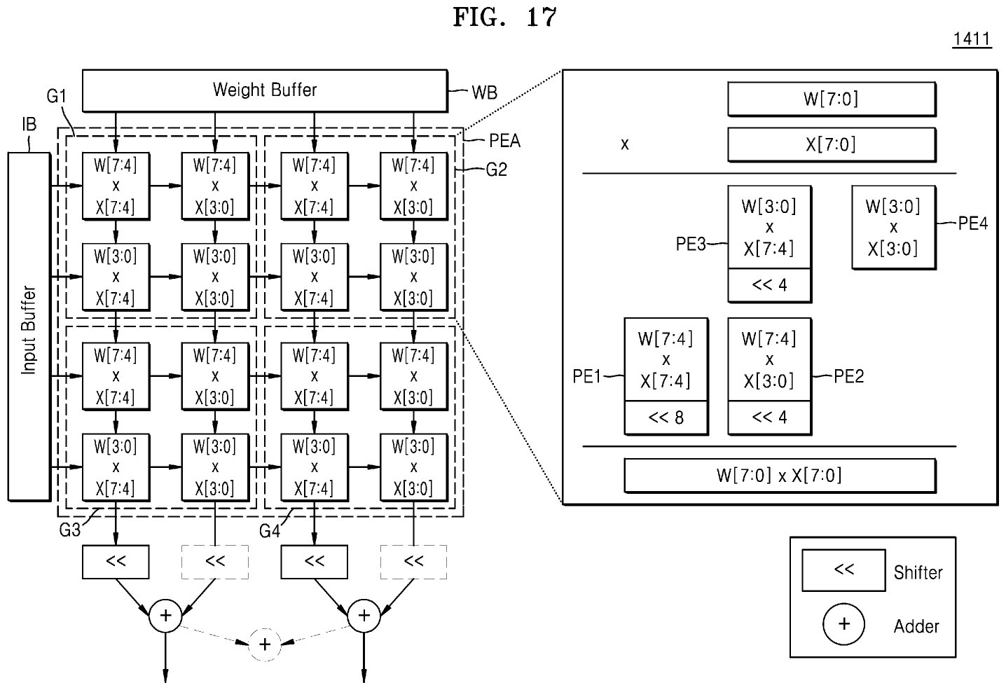

FIG. 17 is a block diagram illustrating examples of a configuration and operations of a sub-core according to an embodiment. The configuration, functions, and operations of the sub-core 1411 of FIG. 17 may respectively correspond to the configuration, functions, and operations of the sub-core 1411 of FIG. 15. Repeated descriptions given with reference to FIGS. 1 to 16 are omitted.

Referring together to FIGS. 3 and 17, FIG. 17 illustrates operations of the sub-core 1411 when an input value and a weight value each include 8 bits. 16 PEs of the PE array PEA may be grouped by every 4 PEs. First to fourth groups G1, G2, G3, and G4 may each include 4 PEs. For example, each of the first to fourth groups G1, G2, G3, and G4 may include 4 PEs arranged in a 2×2 form. Each of the first to fourth groups G1, G2, G3, and G4 may perform a multiplication operation between a 8-bit weight value W[0:7] and a 8-bit input value X[0:7]. Each of the first to fourth groups G1, G2, G3, and G4 may transfer a multiplication operation result to a shifter and/or an adder.

Hereinafter, operations of the second group G2 are described as an example. The second group G2 may be configured to perform a multiplication operation between an 8-bit weight value W[7:0] and an 8-bit input value X[7:0]. Each of the weight value W[7:0] and the input value X[7:0] may be divided into two 4-bit sub-words. For example, the weight value W[7:0] may be divided into a first weight sub-word W[7:4] and a second weight sub-word W[3:0]. For example, the input value X[7:0] may be divided into a first input sub-word X[7:4] and a second input sub-word X[3:0]. The second group G2 may include first to fourth PEs.

The first PE PE1 may perform a multiplication operation between the first weight sub-word W[7:4] and the first input sub-word X[7:4]. A shifter connected to the first PE PE1 may be activated and perform 8-bit left-shifting. The first PE PE1 may transfer a shifted operation result value (which may be alternatively referred to as a partial sum) to the third PE PE3.

The second PE PE2 may perform a multiplication operation between the first weight sub-word W[7:4] and the second input sub-word X[3:0]. A shifter connected to the second PE PE2 may be activated and perform 4-bit left-shifting. The second PE PE2 may transfer a shifted operation result value (which may be alternatively referred to as a partial sum) to the fourth PE PE4.

The third PE PE3 may perform a multiplication operation between the second weight sub-word W[3:0] and the first input sub-word X[7:4]. A shifter connected to the third PE PE3 may be activated and perform 4-bit left-shifting. An adder connected to the third PE PE3 may be activated and may output a first addition value by adding the shifted operation result value of the first PE PE1 to the shifted operation result value of the third PE PE3.

The fourth PE PE4 may perform a multiplication operation between the second weight sub-word W[3:0] and the second input sub-word X[3:0]. An adder connected to the fourth PE PE4 may be activated and may output a second addition value by adding the shifted operation result value of the second PE PE2 to the shifted operation result value of the fourth PE PE4.

An adder connected to the third PE PE3 and the fourth PE PE4 may be activated and may output a third addition value by adding the second addition value to the first addition value. The third addition value may be transferred to the selective adder tree 1412.

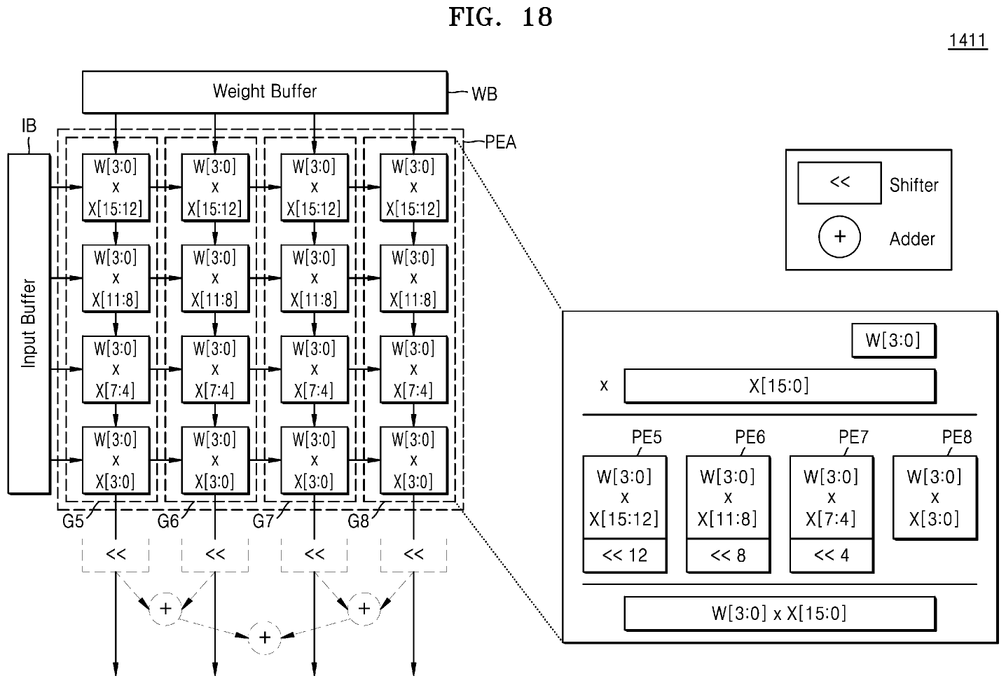

FIG. 18 is a block diagram illustrating examples of a configuration and operations of a sub-core according to an embodiment. The configuration, functions, and operations of the sub-core 1411 of FIG. 18 may respectively correspond to the configuration, functions, and operations of the sub-core 1411 of FIG. 15. Repeated descriptions given with reference to FIGS. 1 to 17 are omitted.

Referring together to FIGS. 3 and 18, FIG. 18 illustrates operations of the sub-core 1411 when an input value includes 16 bits and a weight value includes 4 bits. 16 PEs of the PE array PEA may be grouped by every 4 PEs. Fifth to eighth groups G5, G6, G7, and G8 may each include 4 PEs. For example, each of the fifth to eighth groups G5, G6, G7, and G8 may include 4 PEs arranged in a 4×1 form. Each of the fifth to eighth groups G5, G6, G7, and G8 may perform a multiplication operation between a 4-bit weight value W[3:0] and a 16-bit input value X[15:0]. Each of the fifth to eighth groups G5, G6, G7, and G8 may transfer a multiplication operation result to a shifter and/or an adder.

Hereinafter, operations of the eighth group G8 are described as an example. The eighth group G8 may be configured to perform a multiplication operation between a 4-bit weight value W[3:0] and a 16-bit input value X[15:0]. The 16-bit input value X[15:0] may be divided into 4 4-bit sub-words. For example, the input value X[15:0] may be divided into a first input sub-word X[15:12], a second input sub-word X[11:8], a third input sub-word X[7:4], and a fourth input sub-word X[3:0]. The eighth group G8 may include fifth to eighth PEs PE5, PE6, PE7, and PE8.

The fifth PE PE5 may perform a multiplication operation between the weight value W[3:0] and the first input sub-word X[15:12]. A shifter connected to the fifth PE PE5 may be activated and perform 12-bit left-shifting. The fifth PE PE5 may transfer a shifted operation result value (which may be alternatively referred to as a first partial sum) to the sixth PE PE6.

The sixth PE PE6 may perform a multiplication operation between the weight value W[3:0] and the second input sub-word X[11:8]. A shifter connected to the sixth PE PE6 may be activated and perform 8-bit left-shifting. An adder connected to the sixth PE PE6 may be activated and may output a second partial sum by adding the shifted operation result value to the first partial sum. The sixth PE PE6 may transfer the second partial sum to the seventh PE PE7.

The seventh PE PE7 may perform a multiplication operation between the weight value W[3:0] and the third input sub-word X[7:4]. A shifter connected to the seventh PE PE7 may be activated and perform 4-bit left-shifting. An adder connected to the seventh PE PE7 may be activated and may output a third partial sum by adding the shifted operation result value to the second partial sum. The seventh PE PE7 may transfer the third partial sum to the eighth PE PE8.

The eighth PE PE8 may perform a multiplication operation between the weight value W[3:0] and the fourth sub-word X[3:0]. An adder connected to the eighth PE PE8 may be activated and may add the third partial sum to an operation result value of the eighth PE PE8. An addition result value may be transferred to the selective adder tree 1412.

Referring to FIGS. 16 to 18, the processing core 1410 may receive a first tensor corresponding to a training dataset (or an input value) through the input buffer IB. The processing core 1410 may receive a second tensor corresponding to a weight value through the weight buffer WB. The processing core 1410 may perform a multiplication operation between the first tensor and the second tensor by using a plurality of multipliers. In an embodiment, the first tensor and the second tensor may each have various precisions. In an embodiment, the precision of the first tensor may be equal to or different from the precision of the second tensor.

In an embodiment, the processing core 1410 may process an operation between a shared exponent of the first tensor and a shared exponent of the second tensor by using a shared exponent handler (not shown). The processing core 1410 may perform a MAC operation between a sign and a mantissa of the first tensor and a sign and a mantissa of the second tensor. Here, the sign and the mantissa may include an implicit bit of the mantissa. For example, a result value of the MAC operation may refer to output values of the sub-cores 1411. According to an embodiment, the processing core 1410 may support multiplication operations for various precisions (or bit-widths) by grouping the plurality of multipliers in various manners.

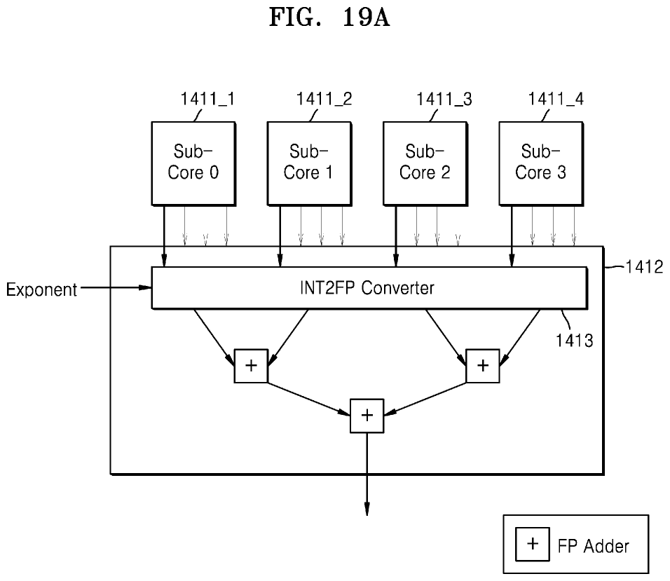

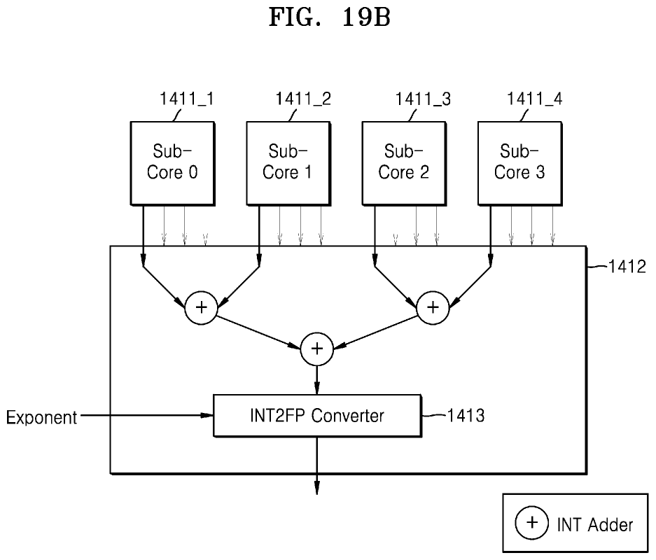

FIGS. 19A and 19B are block diagrams each illustrating examples of a configuration and operations of the selective adder tree 1412 according to an embodiment. The configuration, functions, and operations of the selective adder tree 1412 of FIGS. 19A and 19B may respectively correspond to the configuration, functions, and operations of the selective adder tree 1412 of FIG. 15. Repeated descriptions given with reference to FIGS. 1 to 18 are omitted.

The selective adder tree 1412 may include an INT2FP converter 1413 and at least one adder. The selective adder tree 1412 may adaptively operate for various block sizes. The INT2FP converter 1413 may operate in different manners between the case where the sub-cores of the processing core 1410 each perform a MAC operation on values of the same block and the case where the sub-cores of the processing core 1410 respectively perform MAC operations on values of different blocks. For example, FIG. 19A is a diagram illustrating an example in which each of the sub-cores (that is, 1411_1 to 1411_4) of the processing core 1410 performs a MAC operation on values of the same block. For example, FIG. 19B is a diagram illustrating an example in which the sub-cores (that is, 1411_1 to 1411_4) of the processing core 1410 respectively perform a MAC operation on values of different blocks.

Referring to FIG. 19A, it is assumed that one sub-core performs 128 INT4 MAC operations for one cycle, an input value and a weight value each have 16-bit precision, and a block size is 16. In this case, each of the sub-cores (that is, 1411_1 to 1411_4) may perform an operation between blocks having different shared exponents. Therefore, an output value of each of the sub-cores (that is, 1411_1 to 1411_4) may be transferred to the INT2FP converter 1413. The INT2FP converter 1413 may convert the output values in an integer format into values in a floating-point format. The INT2FP converter 1413 may receive a processed exponent value from a shared exponent handler (not shown). The INT2FP converter 1413 may generate a floating-point value based on the output value of each of the sub-cores (that is, 1411_1 to 1411_4) and the exponent value. A first floating-point adder may output a first addition value by adding a floating-point value corresponding to the output value of the second sub-core 1411_2 to a floating-point value corresponding to the output value of the first sub-core 1411_1. A second floating-point adder may output a second addition value by adding a floating-point value corresponding to the output value of the fourth sub-core 1411_4 to a floating-point value corresponding to the output value of the third sub-core 1411_3. A third floating-point adder may output a final floating-point value by adding the second addition value to the first addition value.

Referring to FIG. 19B, it is assumed that one sub-core performs 128 INT4 MAC operations for one cycle, an input value and a weight value each have 16-bit precision, and a block size is 64. In this case, each of the sub-cores (that is, 1411_1 to 1411_4) may perform an operation between blocks having the same shared exponent. Therefore, an output value of each of the sub-cores may be transferred to an integer adder. A first integer adder may output a third addition value by adding the output value of the second sub-core 1411_2 to the output value of the first sub-core 1411_1. A second integer adder may output a fourth addition value by adding the output value of the fourth sub-core 1411_4 to the output value of the third sub-core 1411_3. A third integer adder may output a final integer value by adding the fourth addition value to the third addition value. The INT2FP converter 1413 may convert the final integer value into a value in a floating-point format. The INT2FP converter 1413 may receive a processed exponent value from a shared exponent handler (not shown). The INT2FP converter 1413 may generate a floating-point value based on the final integer value and the exponent value. According to an embodiment, by using integer addition instead of floating-point addition, the memory load and energy consumption may be significantly reduced.

In an embodiment, the selective adder tree 1412 of the processing core 1410 may obtain a result value of a multiplication operation in a floating-point format, based on an exponent multiplication operation and a MAC operation.

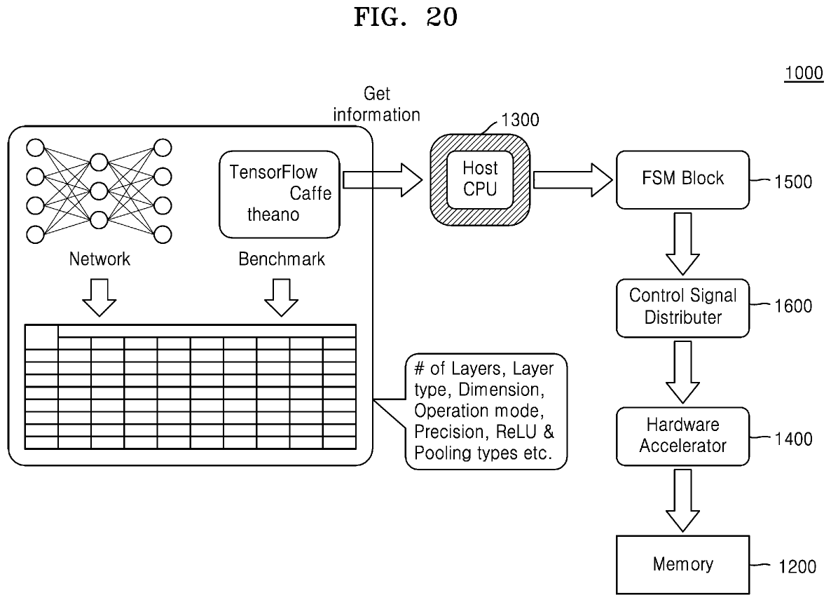

FIG. 20 is a conceptual diagram illustrating operations of the electronic device 1000 according to an embodiment. The configuration, functions, and operations of the electronic device 1000 of FIG. 20 may respectively correspond to the configuration, functions, and operations of the electronic device 1000 of FIG. 3. Repeated descriptions given with reference to FIGS. 1 to 19 are omitted.

Referring together to FIGS. 3 and 20, the electronic device 1000 may obtain information corresponding to an artificial intelligence model. For example, the electronic device 1000 may load the information corresponding to the artificial intelligence model from the memory 1200. For example, the electronic device 1000 may receive the information corresponding to the artificial intelligence model from an external server. For example, the electronic device 1000 may receive, as an input, information corresponding to a targeted artificial intelligence model intended to be trained, through the input/output interface 1100. For example, although the information corresponding to the artificial intelligence model may include data regarding the number of layers of the artificial intelligence model, a layer type, a data dimension, an operation mode, precision, an activation function, a pooling option, and the like, the disclosure is not limited thereto, and the information corresponding to the artificial intelligence model may include various hyperparameters described above.

In an embodiment, the electronic device 1000 may include the processor 1300, a finite-state machine (FSM) block 1500, a signal control distributer 1600, the hardware accelerator 1400, and the memory 1200.

The processor 1300 may generate a control signal for training the artificial intelligence model, based on the information about the artificial intelligence model.

The FSM block 1500 may identify an operation state of the hardware accelerator 1400. The FSM block 1500 may receive a control signal. The FSM block 1500 may optimize the control signal based on the operation state of the hardware accelerator 1400.

The signal control distributer 1600 may provide the control signal optimized by the FSM block 1500 to each component in the hardware accelerator 1400.

The hardware accelerator 1400 may perform a multiplication operation between tensors configured in a block floating-point format. The hardware accelerator 1400 may store a multiplication operation result value in a block floating-point format in the memory 1200.

According to an embodiment, a method of converting a floating-point value into a block floating-point value may be provided. The method may include obtaining a plurality of floating-point values. The method may further include determining, as a shared exponent, an exponent of at least one first floating-point value having a maximum exponent, from among the plurality of floating-point values. The method may further include storing an index of the at least one first floating-point value in a memory. The method may further include right-shifting an implicit bit and explicit bits of a mantissa of at least one second floating-point value not having the maximum exponent, from among the plurality of floating-point values, by as much as a difference between the shared exponent and an exponent of the at least one second floating-point value. The method may further include storing, in the memory, a plurality of block floating-point values including a sign and a mantissa of the at least one first floating-point value, a sign and the mantissa of the at least one second floating-point value, and the shared exponent.

In an embodiment, the method may further include adjusting the sign and the mantissa of the at least one first floating-point value and the sign and the mantissa of the at least one second floating-point value to each have a predefined bit-width.

In an embodiment, the method may further include determining the number of underflow occurrences for the at least one second floating-point value.

In an embodiment, the method may further include changing the predefined bit-width based on the determined number of underflow occurrences.

In an embodiment, the changing of the predefined bit-width may include determining whether the determined number of underflow occurrences is greater than a first critical number. The changing of the predefined bit-width may further include changing the predefined bit-width to a bit-width greater than the predefined bit-width in response to determining that the determined number of underflow occurrences is greater than the first critical number.

In an embodiment, the changing of the predefined bit-width may include determining whether the determined number of underflow occurrences is less than a second critical number. The changing of the predefined bit-width may further include changing the predefined bit-width to a bit-width less than the predefined bit-width in response to determining that the determined number of underflow occurrences is less than the second critical number.

In an embodiment, the number of underflow occurrences may be a number obtained by counting underflows occurring during a process of performing a training operation on one layer of an artificial intelligence model based on one batch including a predefined number of mini-batches.

In an embodiment, the method may further include performing a training operation on an artificial intelligence model based on the plurality of block floating-point values. The method may further include determining whether the training operation has been performed by as many as a predefined number of epochs. The method may further include changing a block size corresponding to the plurality of floating-point values, in response to determining that the training operation has been performed by as many as the predefined number of epochs.

In an embodiment, an implicit bit of a value corresponding to the index stored in the memory may have a first value, and an implicit bit of a value not corresponding to the index stored in the memory may have a second value.

In an embodiment, a first implicit bit of the mantissa of the at least one first floating-point value may have a first value, and a second implicit bit of the mantissa of the at least one second floating-point value may have a second value.

In an embodiment, an electronic device may be provided. The electronic device may include a memory storing at least one instruction. The electronic device may further include at least one processor configured to execute the at least one instruction. The at least one processor may be further configured to obtain a plurality of floating-point values. The at least one processor may be further configured to determine, as a shared exponent, an exponent of at least one first floating-point value having a maximum exponent, from among the plurality of floating-point values. The at least one processor may be further configured to store an index of the at least one first floating-point value in the memory. The at least one processor may be further configured to right-shift an implicit bit and explicit bits of a mantissa of at least one second floating-point value not having the maximum exponent, from among the plurality of floating-point values, by as much as a difference between the shared exponent and an exponent of the at least one second floating-point value. The at least one processor may be further configured to store, in the memory, a plurality of block floating-point values including a sign and a mantissa of the at least one first floating-point value, a sign and the mantissa of the at least one second floating-point value, and the shared exponent.

In an embodiment, a method of processing a block floating-point value may be provided. The method may include obtaining a plurality of block floating-point values, which have a shared exponent, and at least one maximum exponent index. The method may further include determining whether an index of each of the plurality of block floating-point values corresponds to the at least one maximum exponent index. The method may further include determining, as a first value, a first implicit bit of a first block floating-point value corresponding to the index, in response to determining that the index corresponds to the at least one maximum exponent index. The method may further include determining, as a second value, a second implicit bit of a second block floating-point value corresponding to the index, in response to determining that the index does not correspond to the at least one maximum exponent index.

In an embodiment, a method of training an artificial intelligence model by using a hardware accelerator may be provided. The method may include obtaining a training dataset including a plurality of first block floating-point values having a first block size. The method may further include performing a training operation on the artificial intelligence model based on the training dataset. The method may further include repeating the training operation on the artificial intelligence model for a predefined number of epochs. The method may further include reconstructing the training dataset with a plurality of second block floating-point values having a second block size.

In an embodiment, the method may further include performing the training operation based on the reconstructed training dataset. The method may further include repeating the training operation on the artificial intelligence model for the predefined number of epochs.

In an embodiment, the performing of the training operation on the artificial intelligence model based on the training dataset may include performing, in a first epoch from among the predefined number of epochs, the training operation on a first layer of the artificial intelligence model based on a first batch including a predefined number of mini-batches out of the training dataset. In an embodiment, the first batch may have first precision. The performing of the training operation on the artificial intelligence model based on the training dataset may further include converting a training operation result in a floating-point format for the first batch into a block floating-point format. The performing of the training operation on the artificial intelligence model based on the training dataset may further include determining second precision of a second batch including the predefined number of mini-batches out of the training dataset, based on the converted training operation result. The performing of the training operation on the artificial intelligence model based on the training dataset may further include performing, in the first epoch, the training operation on the first layer based on the second batch.

In an embodiment, the determining of the second precision of the second batch including the predefined number of mini-batches out of the training dataset, based on the converted training operation result, may include determining the number of underflow occurrences for the converted training operation result. The determining of the second precision of the second batch including the predefined number of mini-batches out of the training dataset, based on the converted training operation result, may further include determining the second precision based on the determined number of underflow occurrences.

In an embodiment, the determining of the second precision based on the determined number of underflow occurrences may include determining whether the determined number of underflow occurrences is greater than a first critical number. The determining of the second precision based on the determined number of underflow occurrences may further include determining the second precision to be higher than the first precision, in response to determining that the determined number of underflow occurrences is greater than the first critical number.

In an embodiment, the determining of the second precision based on the determined number of underflow occurrences may include determining whether the determined number of underflow occurrences is less than a second critical number. The determining of the second precision based on the determined number of underflow occurrences may further include determining the second precision to be lower than the first precision, in response to determining that the determined number of underflow occurrences is less than the second critical number.

In an embodiment, the performing of the training operation on the artificial intelligence model based on the training dataset may include performing a multiplication operation between a first tensor corresponding to the training dataset and a second tensor corresponding to a weight value of the artificial intelligence model.

In an embodiment, the performing of the multiplication operation may include performing an exponent multiplication operation between a shared exponent of the first tensor and a shared exponent of the second tensor. The performing of the multiplication operation may further include performing a multiply and accumulation (MAC) operation between a sign and a mantissa of the first tensor and a sign and a mantissa of the second tensor. The performing of the multiplication operation may further include obtaining a result value of the multiplication operation in a floating-point format based on the exponent multiplication operation and the MAC operation.

In an embodiment, the precision of the first tensor may be different from the precision of the second tensor.

In an embodiment, the performing of the training operation on the artificial intelligence model based on the training dataset may include converting the result value of the multiplication operation into a block floating-point format.

In an embodiment, an electronic device may be provided. The electronic device may include a memory storing at least one instruction. The electronic device may include at least one processor configured to execute the at least one instruction. The at least one processor may be further configured to obtain a training dataset including a plurality of first block floating-point values having a first block size. The at least one processor may be further configured to perform a training operation on the artificial intelligence model based on the training dataset. The at least one processor may be further configured to repeat the training operation on the artificial intelligence model for a predefined number of epochs. The at least one processor may be further configured to reconstruct the training dataset with a plurality of second block floating-point values having a second block size.

A method according to an embodiment may be implemented in the form of program instructions executable by various computer means and be recorded on a computer-readable recording medium. The computer-readable recording medium may include program instructions, data files, data structures, or the like alone or in combination. The program instructions recorded on the computer-readable recording medium may be program instructions specially designed and configured for the disclosure or program instructions known and available to those of ordinary skill in the field of computer software. Examples of the computer-readable recording medium may include magnetic media such as a hard disk, a floppy disk, and magnetic tape, optical recording media such as compact disc read-only memory (CD-ROM) and a digital versatile disk (DVD), magneto-optical media such as a floptical disk, and hardware devices such as ROM, RAM, and flash memory, which are specially configured to store and execute program instructions. Examples of the program instructions may include machine language code produced by a compiler and high-level language code executable by a computer by using an interpreter or the like.

Some embodiments of the disclosure may be implemented in the form of a recording medium including instructions executable by a computer, such as program modules executed by a computer. The computer-readable recording medium may be any available medium accessible by a computer and includes volatile and non-volatile media and separable and non-separable media. In addition, the computer-readable recording medium may include a computer storage medium and a communication medium. The computer-readable recording medium includes volatile and non-volatile media and separable and non-separable media, which are implemented by any method or technique for storing information, such as computer-readable instructions, data structures, program modules, or other data. The communication medium typically includes computer-readable instructions, data structures, program modules, other data in modulated data signals such as carrier waves, or other transmission mechanisms, and includes any information transfer medium. In addition, some embodiments of the disclosure may be implemented in the form of a computer program or computer program product including instructions executable by a computer, such as a computer program executed by a computer.

In an embodiment, a machine-readable storage medium may be provided in the form of a non-transitory storage medium. Here, the term “non-transitory storage medium” only means that the storage medium is tangible and does not include signals (for example, electromagnetic waves), whether data is semipermanently or temporarily stored in the storage medium or not. For example, the “non-transitory storage medium” may include a buffer in which data is temporarily stored.

According to an embodiment, a method according to various embodiments may be provided while included in a computer program product. The computer program product may be traded as merchandise between a seller and a purchaser. The computer program product may be distributed in the form of a machine-readable storage medium (for example, CD-ROM) or may be distributed (for example, downloaded or uploaded) online through an application store or directly between two user devices (for example, smartphones). In the case of online distribution, at least a portion of the computer program product (for example, a downloadable app) may be at least temporarily stored in a machine-readable storage medium, such as a memory of a server of a manufacturer, a server of an application store, or a relay server, or may be temporarily generated.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of training an artificial intelligence model by using a hardware accelerator, the method comprising:
obtaining a training dataset comprising a plurality of first block floating-point values having a first block size;
performing a training operation on the artificial intelligence model, based on the training dataset;
repeating the training operation on the artificial intelligence model for a predefined number of epochs; and
reconstructing the training dataset with a plurality of second block floating-point values having a second block size.

2. The method of claim 1, further comprising:
performing the training operation based on the reconstructed training dataset; and
repeating the training operation on the artificial intelligence model for the predefined number of epochs.

3. The method of claim 1, wherein the performing of the training operation on the artificial intelligence model, based on the training dataset, comprises:
performing, in a first epoch from among the predetermined number of epochs, the training operation on a first layer of the artificial intelligence model, based on a first batch comprising a predefined number of mini-batches out of the training dataset, the first batch having first precision;
converting a training operation result in a floating-point format for the first batch into a block floating-point format;
determining second precision of a second batch comprising the predefined number of mini-batches out of the training dataset, based on the converted training operation result; and
performing, in the first epoch, the training operation on the first layer, based on the second batch.

4. The method of claim 3, wherein the determining of the second precision of the second batch comprising the predefined number of mini-batches out of the training dataset, based on the converted training operation result, comprises:
determining a number of underflow occurrences for the converted training operation result; and
determining the second precision based on the determined number of underflow occurrences.

5. The method of claim 4, wherein the determining of the second precision based on the determined number of underflow occurrences comprises:
determining whether the determined number of underflow occurrences is greater than a first critical number; and
determining the second precision to be higher than the first precision, in response to determining that the determined number of underflow occurrences is greater than the first critical number.

6. The method of claim 4, wherein the determining of the second precision based on the determined number of underflow occurrences comprises:
determining whether the determined number of underflow occurrences is less than a second critical number; and
determining the second precision to be lower than the first precision, in response to determining that the determined number of underflow occurrences is less than the first critical number.

7. The method of claim 1, wherein the performing of the training operation on the artificial intelligence model, based on the training dataset, comprises performing a multiplication operation between a first tensor corresponding to the training dataset and a second tensor corresponding to a weight value of the artificial intelligence model.

8. The method of claim 7, wherein the performing of the multiplication operation comprises:
performing an exponent multiplication operation between a shared exponent of the first tensor and a shared exponent of the second tensor;
performing a multiply and accumulation (MAC) operation between a sign and a mantissa of the first tensor and a sign and a mantissa of the second tensor; and
obtaining a result value of the multiplication operation in a floating-point format, based on the exponent multiplication operation and the MAC operation.

9. The method of claim 7, wherein the performing of the training operation on the artificial intelligence model, based on the training dataset, comprises converting a result value of the multiplication operation into a block floating-point format.

10. The method of claim 7, wherein precision of the first tensor is different from precision of the second tensor.

11. An electronic device comprising:
a memory storing at least one instruction; and
at least one processor configured to execute the at least one instruction to:
obtain a training dataset comprising a plurality of first block floating-point values having a first block size;
perform a training operation on an artificial intelligence model, based on the training dataset;
repeat the training operation on the artificial intelligence model for a predefined number of epochs; and
reconstruct the training dataset with a plurality of second block floating-point values having a second block size.

12. The electronic device of claim 11, wherein the at least one processor is further configured to:
perform the training operation based on the reconstructed training dataset; and
repeat the training operation on the artificial intelligence model for the predefined number of epochs.

13. The electronic device of claim 11, wherein the at least one processor is further configured to:
perform, in a first epoch from among the predetermined number of epochs, the training operation on a first layer of the artificial intelligence model, based on a first batch comprising a predefined number of mini-batches out of the training dataset, the first batch having first precision;
convert a training operation result in a floating-point format for the first batch into a block floating-point format;
determine second precision of a second batch comprising the predefined number of mini-batches out of the training dataset, based on the converted training operation result; and
perform, in the first epoch, the training operation on the first layer, based on the second batch.

14. The electronic device of claim 13, wherein the at least one processor is further configured to:
determine a number of underflow occurrences for the converted training operation result; and
determine the second precision based on the determined number of underflow occurrences.

15. The electronic device of claim 14, wherein the at least one processor is further configured to:
determine whether the determined number of underflow occurrences is greater than a first critical number; and
determine the second precision to be higher than the first precision, in response to determining that the determined number of underflow occurrences is greater than the first critical number.

16. The electronic device of claim 14, wherein the at least one processor is further configured to:
determine whether the determined number of underflow occurrences is less than a second critical number; and
determine the second precision to be lower than the first precision, in response to determining that the determined number of underflow occurrences is less than the first critical number.

17. The electronic device of claim 11, wherein the at least one processor is further configured to perform a multiplication operation between a first tensor corresponding to the training dataset and a second tensor corresponding to a weight value of the artificial intelligence model.

18. The electronic device of claim 17, wherein the at least one processor is further configured to:
perform an exponent multiplication operation between a shared exponent of the first tensor and a shared exponent of the second tensor;
perform a multiply and accumulation (MAC) operation between a sign and a mantissa of the first tensor and a sign and a mantissa of the second tensor; and
obtain a result value of the multiplication operation in a floating-point format, based on the exponent multiplication operation and the MAC operation.

19. The electronic device of claim 17, wherein the at least one processor is further configured to convert a result value of the multiplication operation into a block floating-point format.

20. A non-transitory computer-readable recording medium, the non-transitory computer-readable recording medium having recorded thereon a program for performing the method of:
obtaining a training dataset comprising a plurality of first block floating-point values having a first block size;
performing a training operation on an artificial intelligence model, based on the training dataset;
repeating the training operation on the artificial intelligence model for a predefined number of epochs; and
reconstructing the training dataset with a plurality of second block floating-point values having a second block size.
